(19) United States
(12) Patent Application Publication
(10) Pub. No.: US 2026/0208770 A1
(43) Pub. Date: Jul. 23, 2026

(54) AN AUTOMATED STORAGE AND RETRIEVAL SYSTEM COMPRISING LOCKABLE BARRIERS FOR SAFE TRANSFER OF PERSONS INTO A TRANSPORT VEHICLE ON A LIVE GRID, AND ASSOCIATED METHOD

(71) Applicant: AutoStore Technology AS, Nedre Vats (NO)

(72) Inventors: Jørgen Djuve Heggebø, Langhus (NO); Geir Vikingstad, Haugesund (NO); Kenneth Müller, Vormedal (NO)

(21) Appl. No.: 19/138,000

(22) PCT Filed: Dec. 6, 2023
(86) PCT No.: PCT/EP2023/084618

§ 371 Date: Jun. 11, 2025

(30) Foreign Application Priority Data
Dec. 16, 2022 (NO) 20221348

(51) Int. Cl. B61B 1/02; B61B 5/02; B61C 13/04; B61F 5/50; B65G 1/04; E05B 47/00

(52) U.S. Cl. CPC B61B 1/02; B61B 5/02; B61C 13/04; B61F 5/50; B65G 1/0464; E05B 47/0001; B65G 2207/40

(57) ABSTRACT

It is described an automated storage and retrieval system (1) comprising: —a rail system (108) comprising a first set of parallel rails (110) extending in a first direction (X) across the top of a frame structure (100) formed by a plurality of upright members (102), and a second set of parallel rails (111) in the horizontal plane arranged in a second direction (Y) perpendicular to the first set of parallel rails (110), to guide movement of container handling vehicles (201; 301; 401) in the first direction (X) and the second direction (Y), and wherein the rail system (108) comprises an operating area (20); —a plurality of container handling vehicles (201; 301; 401) operating on the rails (110, 111) in the operating area (20); —transport vehicle (501′) movable on the rail system (108), the transport vehicle (501′) comprising an enclosure (E) defining an enclosed first area (510) for transporting a person within, the enclosure (E) comprising a lockable barrier (520′) configured to provide access for a person into the first area (510); —a second area (30; 510′), partitioned from the operating area (20) and comprising a lockable barrier (31; 520″) configured to provide access for a person into the second area (30; 510′) from the first area (510); wherein both lockable barriers (520′, 31; 520″) are configured to: —unlock when movement of the transport vehicle (501′) is physically prevented relative to the second area (30; 510′); and —lock when movement of the transport vehicle (501′) is allowed relative to the second area (30; 510′). It is further described a method of transporting a person between a first area (510) and a second area (30; 510′) of an automated storage and retrieval system (1).

### TECHNICAL FIELD

The invention relates to an automated storage and retrieval system comprising a rail system comprising an operating area, a plurality of container handling vehicles operating on the rails of the rail system in the operating area, a transport vehicle movable on the rail system, the transport vehicle comprising an enclosure defining an enclosed first area for transporting a person within and comprising a lockable barrier for entry into the first area, and a second area partitioned from the operating area and comprising a lockable barrier configured to provide access for a person into the second area from the first area. The invention provides for safe transfer of a person y into and exit from a transport vehicle on a live grid.

It is further described an associated method.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 (showing a cavity-type container handling vehicles) and as described in e.g. WO2015/193278A1 and WO2019/206488A1, the contents of which are incorporated herein by reference.

FIG. 3 shows an alternative configuration of a container handling vehicle 301 with a cantilever construction (referred to as a cantilever-type container handling vehicle). Such a vehicle is described in detail in e.g. NO317366, the contents of which are also incorporated herein by reference.

The cavity-type container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity-type container handling vehicles 401 shown in FIGS. 4 and 5 may have a footprint which is larger than the lateral area defined by a storage column 105 as shown in FIGS. 1 and 4, e.g. as is disclosed in WO2014/090684A1 or WO2019/206488A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a drop-off port column where the container handling vehicles 201,301,401 can drop off storage containers 106 to be transported to an access or a transfer station, and the second port column 120 may be a pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075938A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 116, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles.

Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of the invention is to provide safe access of operators or personnel on an active or “live” automated storage and retrieval system.

### SUMMARY OF THE INVENTION

The present invention is set forth and characterized in the independent claims, while the dependent claims describe other optional features.

Common to all of the examples of the invention as described herein is the possibility of entering and exiting a transport vehicle on a grid which is live. “Live” shall be understood that it is possible to enter and exit a transport vehicle with personnel on a part of an automated storage and retrieval system where the container handling vehicles described e.g. with reference to FIGS. 1-4 operate without shutting down the system.

The present invention relates to an automated storage and retrieval system comprising:
a rail system comprising a first set of parallel rails extending in a first direction across the top of a frame structure formed by a plurality of upright members, and a second set of parallel rails in the horizontal plane arranged in a second direction perpendicular to the first set of parallel rails, to guide movement of container handling vehicles in the first direction and the second direction, and wherein the rail system comprises an operating area;
a plurality of container handling vehicles operating on the rails in the operating area;
transport vehicle movable on the rail system, the transport vehicle comprising an enclosure defining an enclosed first area for transporting a person within, the enclosure comprising a lockable barrier configured to provide access for a person into the first area;
a second area, partitioned from the operating area and comprising a lockable barrier configured to provide access for a person into the second area from the first area;
   wherein both lockable barriers are configured to:
unlock when movement of the transport vehicle is physically prevented relative to the second area; and
lock when movement of the transport vehicle is allowed relative to the second area.

The transport vehicle is a vehicle of sufficient size for a person, e.g. an operator or other personnel, to enter into or onto it. When the person is inside or on the transport vehicle, he/she is protected against the container handling vehicles operating in the operating area. The enclosure may encircle the person or it may provide all round protection, for example, through including a roof. When the person is inside or on the transport vehicle, the person is protected against the container handling vehicles operating in the operating area.

The transport vehicle may be a transport vehicle with a primary task of transporting a person or personnel.

Alternatively, the transport vehicle may be a vehicle which normally has other primary tasks such as e.g. storage container handling tasks, picking tasks, etc. and which has a person transport or personnel transport function as a secondary task.

The lockable barrier of the enclosure and the lockable barrier of the second area are operable between a state where they are unlocked allowing passage therethrough and a state where they are locked preventing passage therethrough, such that the barriers prevent passage of a person except when the transport vehicle is physically prevented from movement.

The lockable barriers can be arranged in the sides of the transport vehicle and the second area if the second area is arranged next to the transport vehicle.

Alternatively, if the second area is located above the transport vehicle, the lockable barriers can be arranged in a roof or ceiling of the transport vehicle and in the floor of the second area. As a further alternative, if the second area is arranged below the transport vehicle, the lockable barriers can be arranged in a floor of the transport vehicle and in the roof or ceiling of the second area. The lockable barrier of the transport vehicle can thus only be unlocked and opened when the transport vehicle is physically prevented from movement. The barriers can thus be opened only when the transport vehicle is securely connected to the second area.

When the lockable barriers are locked, they are also always closed preventing passage of a person therethrough.

When the lockable barriers are unlocked, they are either open allowing passage of a person therethrough or they can be opened such that a person is allowed to pass therethrough.

When the lockable barrier of the transport vehicle and the lockable barrier of the second area are arranged directly next to each other, the risk of an operator's impact with a container handling vehicle when moving between the first area and the second area is eliminated or at least greatly minimized. I.e, it is preferably no cells between the first area and the second area, such that the person can move directly between the first area and the second area. As such, although the transport vehicle is positioned within the operating area, the position within the operating area next to the barrier of the second area can be seen as a safe position where it is not a risk that the person is hit or collides with a container handling vehicle operating in the operating area.

The barrier of the transport vehicle and the barrier of the second area may be fail-safe locked.

This ensures that the barriers are always locked when the transport vehicle is not physically, i.e. securely, connected to the second area eliminating the risk of unintentional opening.

The transport vehicle may comprise a first set of wheels for driving in the first direction and a second set of wheels for driving in the second direction.

As an alternative to wheels, the transport vehicle may have belts for moving on top of the rail system.

The transport vehicle may comprise a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

The transport vehicle may comprise a wheel drive motor for driving the first set of wheels and/or the second set of wheels.

There may be one wheel drive motor for driving both the wheels in the first set of wheels and the wheels in the second set of wheels. Alternatively, there may be one wheel drive motor for driving the first set of wheels and one motor for driving the second set of wheels.

The automated storage and retrieval system may comprise a locking assembly in the form of a mechanical locking assembly, a combination of an electric and mechanical locking assembly, a magnetic locking assembly or an electro-magnetic locking assembly providing the physical prevention.

In one aspect, the locking assembly may be configured to lock a docking probe, and where:
the locking assembly is arranged at or in the second area and the docking probe extends outwardly from the transport vehicle, or
the locking assembly is arranged at or in the transport vehicle and the docking probe extends outwardly from the second area.

In one aspect, the locking assembly comprises:
an outer member having a U-shape forming a receiving portion within the U-shape and where an outer upper end and an outer lower end of the outer member may be securely connected to an inside of a side which forms the enclosure;
an inner member which is movable within the receiving portion of the outer member, wherein the inner member has a U-shape forming a receiving portion of the inner member oriented in the same direction as the outer member, and wherein the U-shape of the inner member has an upper end and lower end; and wherein the side comprises a hole which is flush with the receiving portion of the inner member to allow passage of the docking probe therethrough.

The inner member may be connected to the outer member by a pretension spring or springs which exert a force on the inner member in a direction towards the hole in the side.

The lockable barrier may comprise lock members which protrude sideways as an extension of the barrier and wherein each of the lock members comprises an opening such that each of the lock member is configured to receive the respective upper end and lower end of the inner member such that the barrier is locked when the inner member is in an extended position.

It is clear that in the latter example the locking assembly is arranged at the transport vehicle and the docking probe on the second area, however this can be interchanged as required.

It is also possible to provide a dual lock where each of the second area and the transport vehicle comprises a docking probe and a locking assembly each.

The docking probe may comprise a pretensioned latching mechanism which is pivotably arranged at pivot point inside the docking probe.

The latching mechanism may be configured such that when an outer force from the barrier is not exerted on the latching mechanism, the latching mechanism is in an extended position where it extends sideways beyond an outer periphery of the docking probe, and when the outer force from the barrier is exerted on the latching mechanism, the pretensioned force is overcome and the latching mechanism is forced to a retracted position inside an outer periphery of the docking probe.

Normally an end face of the barrier exerts the outer force on the latching mechanism when the barrier is locked. However, upon movement of the barrier from being locked to being unlocked, the outer force on the latching mechanism is not exerted anymore and the latching mechanism is moved to an extended position.

In one aspect, when the outer force from the barrier is not exerted on the latching mechanism, a back end of the latching mechanism can be configured to abut the side.

A portion of the inner member which is in contact with the pretension spring or springs may have an upper part with a first thickness and a lower part with a second thickness, where the first thickness is thicker than the second thickness, and where the docking probe may initially be in contact with the lower part.

Upon vertical downwards movement of the locking assembly relative the docking probe, the docking probe may be configured to be in contact with the upper part instead of the lower part thereby compressing the spring or springs which involves that the upper and lower end of the inner member are moved out of the locking relationship with the openings of the lock member.

The vertical movement can be performed by using a track shift or wheel lift mechanism of the transport vehicle to lower the transport vehicle such that all of the wheels in both the first set of wheels and the second set of wheels are in contact with the rails. The barrier is now in theory unlocked. This means that the barrier is allowed to e.g. slide open. However, the final locking step which prevents movement of the transport vehicle relative the wall has not been activated.

A locking member may be connected to the side of the transport vehicle to a side of the locking assembly, the locking member is pretensioned by a lock spring and comprises a wedge member arranged at or below a lowermost elevation of the docking probe such that when the barrier is locked, the wedge member is arranged to the side of the docking probe and cannot influence vertical movement of the locking assembly relative the docking probe, and when the barrier is unlocked, the wedge member is arranged between the docking probe and the inner member such that it prevents relative vertical movement of the locking assembly relative the docking probe thereby preventing that the transport vehicle may move when the barrier is unlocked.

The barrier may comprise a push member arranged on the opposite side of the locking assembly compared to the locking member, and the push member may be configured to exert a force on the locking member to move the wedge member from between the docking probe and the inner member to the side of the docking probe.

The automated storage and retrieval system may further comprise a control system for communication with the container handling vehicles and the first operating entry vehicle.

The control system may comprise a transmitter and a receiver for communication with the container handling vehicles and the first operating entry vehicle.

The automated storage and retrieval system may comprise a locking assembly in the form of a combination of an electric and mechanical locking assembly, where the locking assembly comprises a first part and a second part, where the first part is lockable to the second part representing a locked state of the locking assembly and when in the locked state, the locking assembly informs the control system the control system allows unlocking of the barriers.

The system may comprise a barrier lock locking the barriers.

The barrier lock may comprise a transmitter and a receiver for communicating with a control system to lock or unlock the barrier lock.

In one aspect, the barrier lock may comprise a transmitter and a receiver for communicating with the locking assembly forming a local state recognition system, and where the barrier lock only allows unlocking of the barrier when the locking assembly confirms by communication to the barrier lock that it is in its locked state.

The transport vehicle may comprise an emergency stop, where the emergency stop may comprise a transmitter configured to transmit an emergency stop signal to the control system.

When receiving the emergency stop signal, the control system may shut down the automated storage and retrieval system. The emergency stop can for example be connected to the control system such that upon a signal from the emergency stop, the control system can immediately shut down the automated storage and retrieval system. For example, the emergency stop may comprise a transmitter and the control system may comprise a receiver for receiving a signal from the transmitter.

The control system may then send stop signal to all vehicles or it may cut the power.

Similarly, the second area may comprise an emergency stop with similar features and functions.

The transport vehicle may be configured to receive routing instructions from the control system to a position next to the second area, and when it is verified that the transport vehicle is at the position next to the service area and the lockable barrier on the transport vehicle and the lockable barrier in the second area are unlocked, passage of a person therethrough is allowed, while when the lockable barrier on the transport vehicle and the lockable barrier in the second area are locked, passage of an operator therethrough is prevented.

The control system may comprise a verification device for verifying that the transport vehicle is at the position next to the second area.

The verification device may be one or more sensors at or close to the position next to the second area and the one or more sensors may be configured to confirm that the transport vehicle is at the position.

The transport vehicle may comprise a support for stabilizing the transport vehicle.

The support may be movable between a raised position where it is lifted from the rail system and a lowered position where it is in contact with the rail system.

The support is preferably configured to interact with the rail system. The support may interact with the rail system in order to stabilize the transport vehicle during entering and exit of a person. The support may be used in addition to lowering all wheels into contact with the rail system during entering and exit of a person. It may also provide for additional support which may be required when bringing container handling vehicles, tools etc. into or out of the first area of the transport vehicle.

The second area may be a safe area for performing service on the container handling vehicles and where the container handling vehicles is prevented from self-movement. The second area may have rails such that the container handling vehicles in need of maintenance or service can be pushed into the safe area on the rails or operate by self-movement.

The second area may be a temporary area within the operating area.

The second area can thus be a temporary “island” within the operating area. The “island” may be a temporary or a permanent area. The temporary or permanent area may be used for protecting personnel when doing maintenance, repair and/or installation within the operating area. I.e., while the operating area is operational, i.e. “live”, the second area is protected from the operating area.

If the second area is for example a temporary area, it may serve as a safe area for e.g. performing maintenance or repair on:
parts of the rail system,
on upright members forming part of the frame structure, or
chargers for the container handling vehicles, where the chargers can be arranged within the temporary second area or in the proximity of the second area.

In one aspect, the system may comprise a second transport vehicle, where the second transport vehicle may comprise an enclosure defining the second area for transporting a person within.

The second area may thus be a second transport vehicle. The second transport vehicle may be identical to the transport vehicle or it may be a container handling vehicle with sufficient space for a person to enter into or onto it.

In some situations, it may be required to transfer a person from the transport vehicle to the second transport vehicle. Such situations may e.g. be if the transport vehicle malfunctions or if one or more personnel shall be transported over large distances using the second transport vehicle.

The present invention also relates to a method of transporting a person between a first area and a second area of an automated storage and retrieval system as defined above, wherein the method comprising the steps of:
positioning the transport vehicle at a position next to the second area;
locking the transport vehicle at the position at the second area such that the lockable barrier on the transport vehicle and the lockable barrier in the second area are unlocked;
the person entering the first area of the transport vehicle through the lockable barriers.

The method may comprise, prior to the person entering the first area of the transport vehicle, a step of:
utilizing a verification device to verify that the transport vehicle is at the position next to the second area.

When the transport vehicle is in position, the method may comprise the steps of:
lowering all wheels of the first set of wheels and the second set of wheels to the rail system.

All of the wheels may be lowered to stabilize the vehicle and prevent the vehicle from unintentional movement when a person enters or exits the transport vehicle.

When the transport vehicle is at the personnel transfer position, the method may comprise a step of:
lowering a support into contact with the rail system.

The support is preferably configured to interact with the rail system. The support may interact with the rail system in order to stabilize the transport vehicle during entering and exit of a person. The support may be used in addition to lowering all wheels into contact with the rail system during entering and exit of a person. It may also provide for additional support which may be required when bringing container handling vehicles, tools etc. into or out of the first area of the transport vehicle.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The first and second set of rails of the rail system may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell”. In arrangements where one direction of rails has only a single track, the grid cell may extend a full rail-width on those sides.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention.

The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIG. 6 shows details of a first exemplary transport vehicle for the automated storage and retrieval system;

FIG. 7A shows a perspective view of an automated storage and retrieval system comprising a rail system with an operating area, a second area in the form of a safe area partitioned from the operating area, and a transport vehicle which moves on the rail system, the transport vehicle comprising an enclosure defining an enclosed first area for transporting a person within, the enclosure comprising a lockable barrier configured to provide access for a person into the first area;

FIG. 7B is a similar view as in FIG. 7A, but in FIG. 7B the transport vehicle has moved to a position next to the second area such that one of the lockable barriers of the transport vehicle is positioned in front of a lockable barrier of the second area, however the transport vehicle is allowed to move relative the second area since the barriers are locked;

FIG. 7C is a similar view of FIG. 7B, but in FIG. 7C the lockable barrier of the transport vehicle and the lockable barrier of the second area are unlocked because movement of the transport vehicle relative to the second area is physically prevented;

FIG. 8A shows a perspective view of an automated storage and retrieval system comprising a rail system with an operating area, two transport vehicles within the operating area and where the vehicles are arranged at a distance from each other, wherein the first transport vehicle comprises an enclosure defining an enclosed first area for transporting a person within, the enclosure comprising a lockable barrier configured to provide access for a person into the first area, and the second the transport vehicle comprises an enclosure defining an enclosed second area for transporting a person within, the enclosure comprising a lockable barrier configured to provide access for a person into the second area;

FIG. 8B is a similar view as in FIG. 8A where the transport vehicles are positioned next to each other and the barriers are in theory unlocked such that the doors can be open, however the transport vehicles are not locked to each other since none of the doors has been opened;

FIG. 8C is a similar view as in FIG. 8B with the transport vehicles positioned next to each other and the barriers are unlocked, but since the doors have been opened the transport vehicles are locked to each other and aa person can pass between the vehicles;

FIGS. 9A-9E show different steps of a locking sequence of a first example of a mechanical locking assembly for physically preventing that the transport vehicle move relative the second area;

FIGS. 10A-10F show different steps of a locking sequence of a second example of a mechanical locking assembly for physically preventing that the transport vehicle move relative the second area;

FIG. 11A is a side view of a second example of a transport vehicle with a locking assembly in the form of a combination of an electric and mechanical locking assembly;

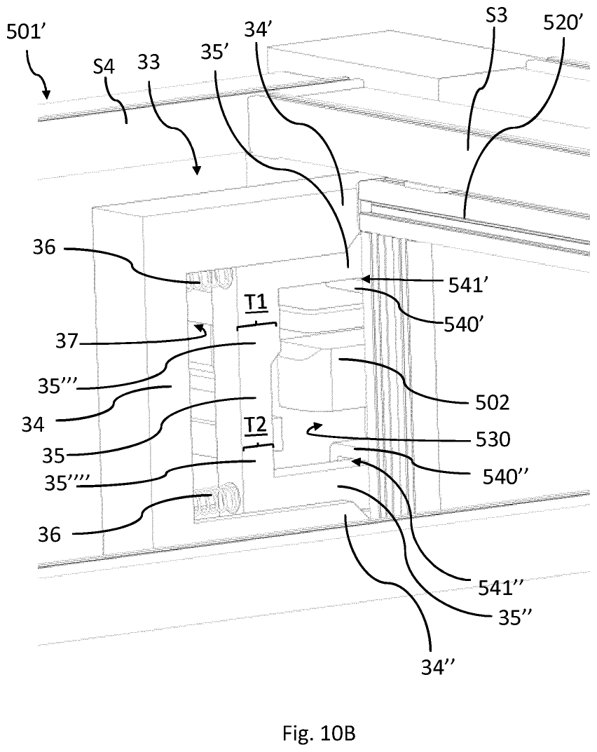

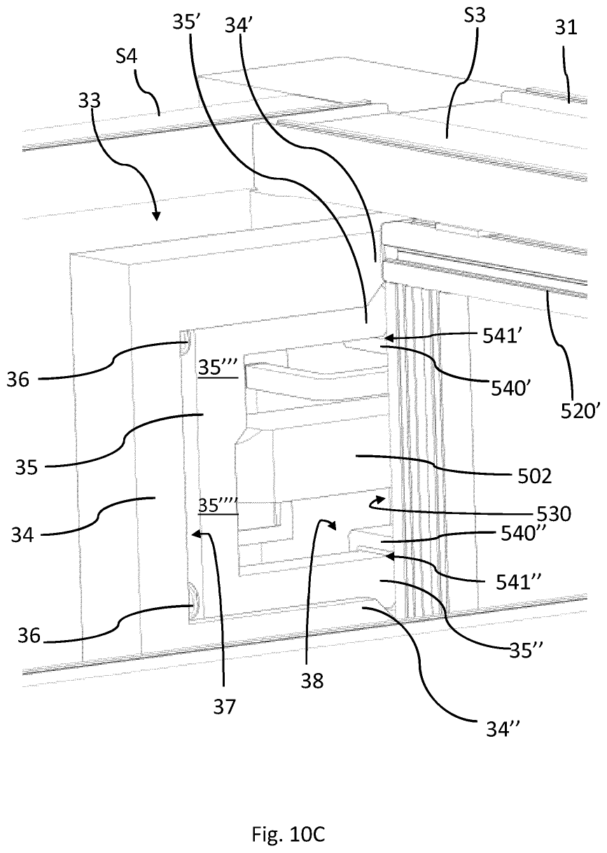

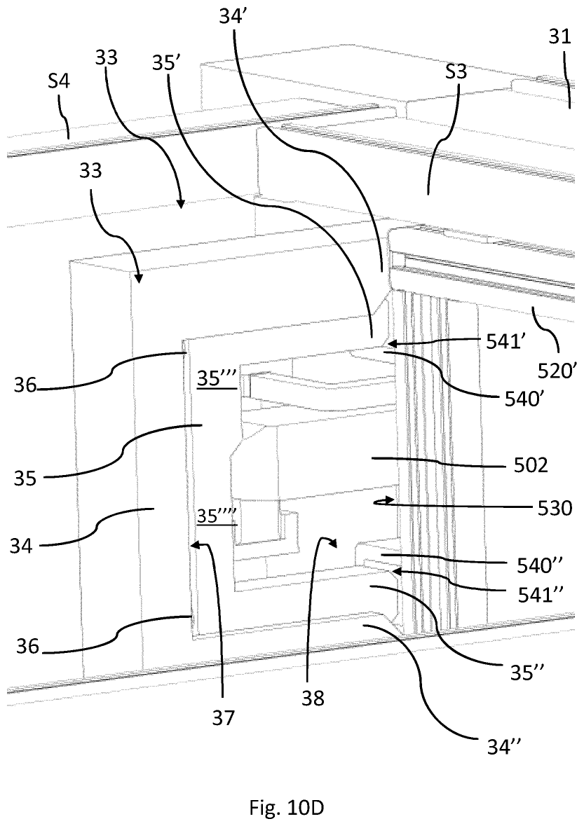

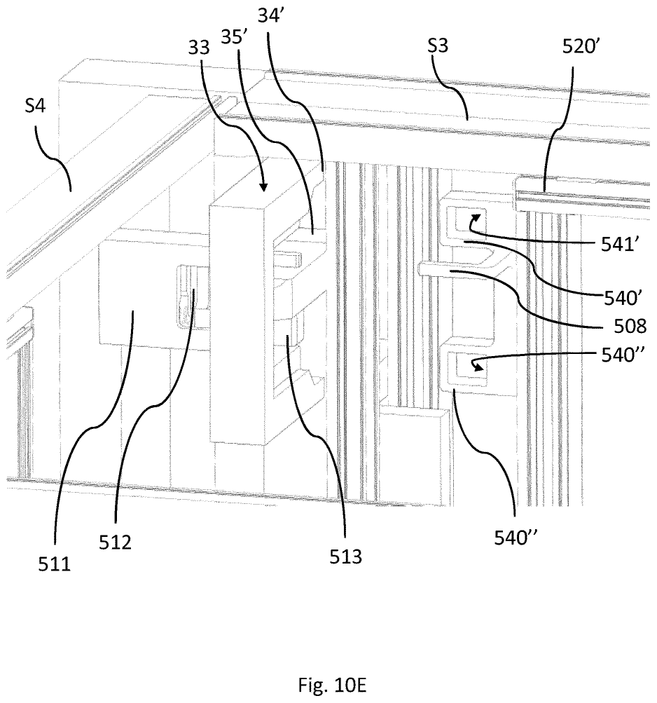

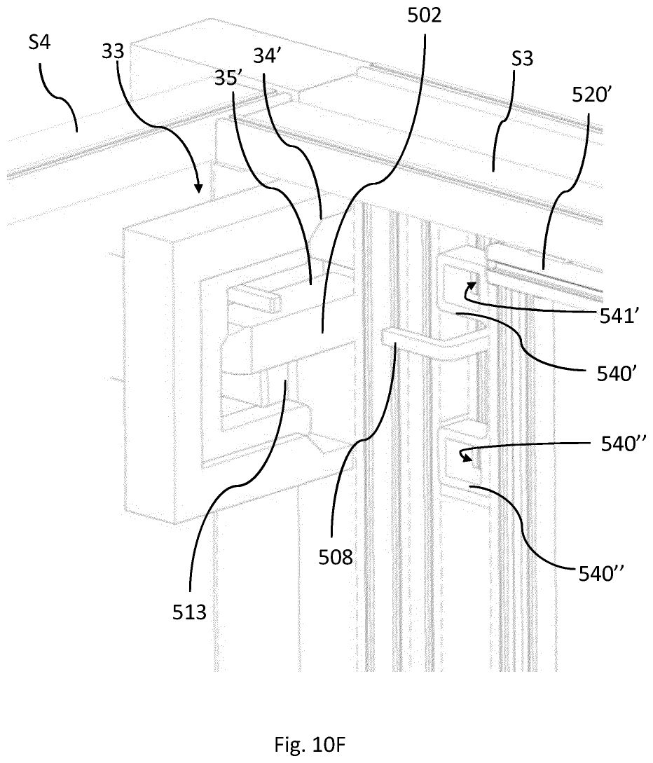

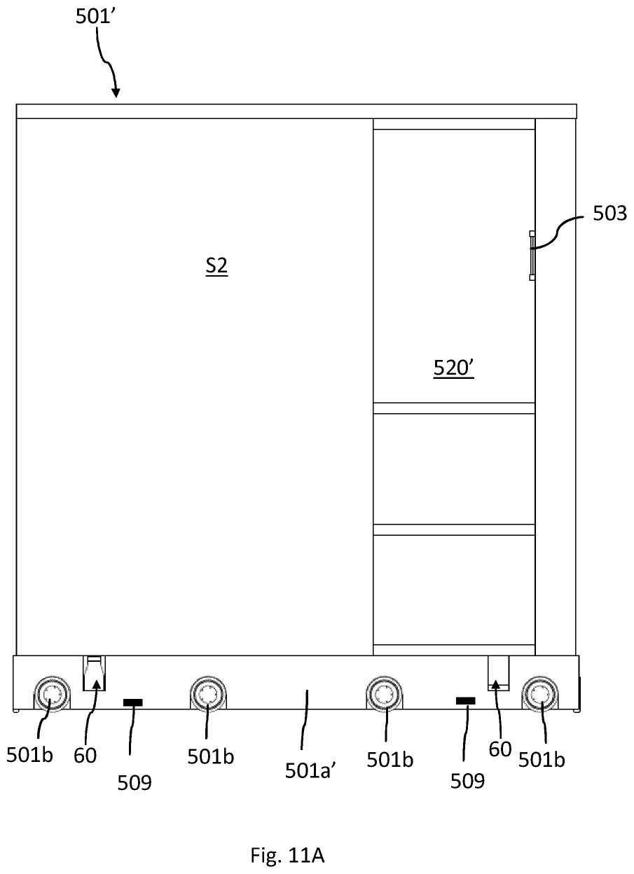

FIGS. 10B-10C are a side perspective views of an automated storage and retrieval system comprising a combination of an electric and mechanical locking assembly, wherein the automated storage and retrieval system comprising: a rail system which comprises an operating area, a container handling vehicle operates on rails in the operating area, a transport vehicle operates on the rail system and comprises an enclosure defining an enclosed first area for transporting a person within, the enclosure comprising a lockable barrier configured to provide access for a person into the first area, and a second area in the form of a safe area partitioned from the operating area and comprising a lockable barrier configured to provide access for a person into the second area from the first area;

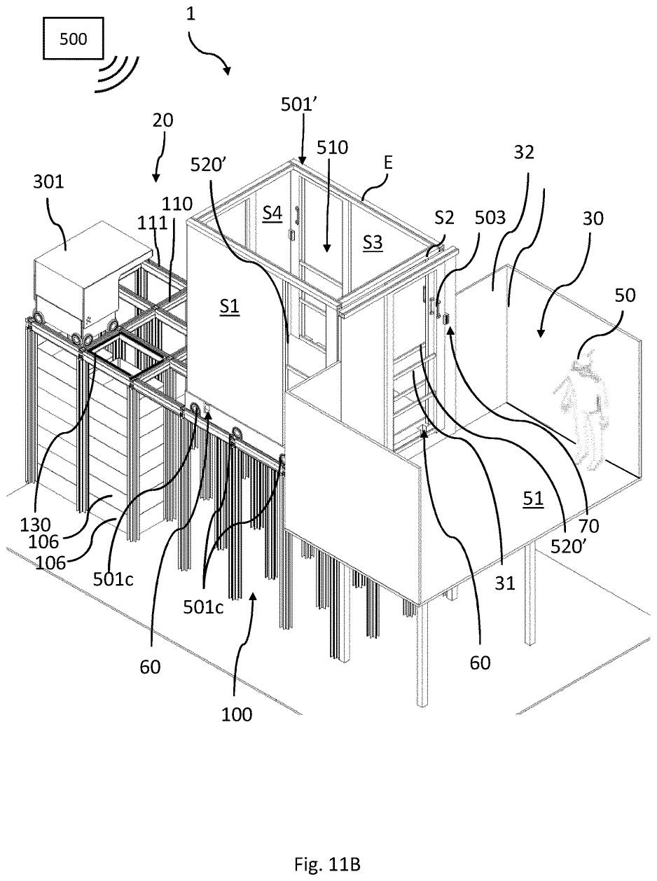

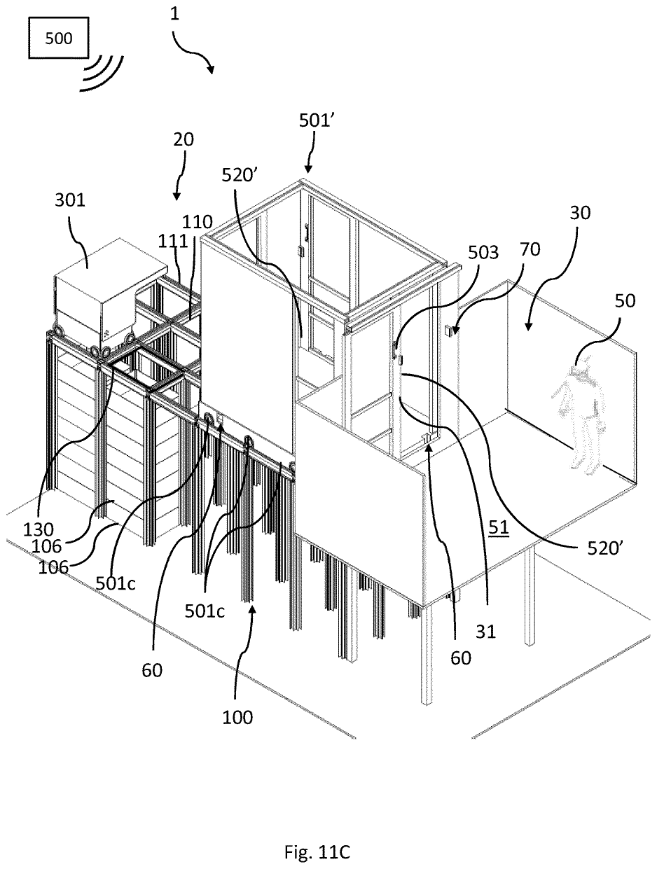

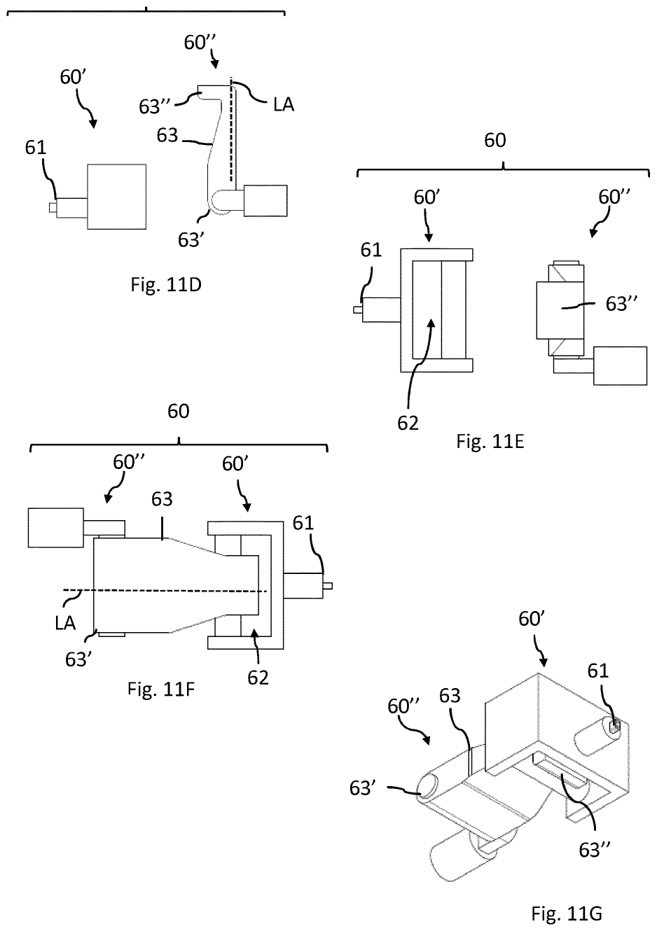

FIGS. 10D-11G are detailed views of a locking sequence of the locking assembly for the automated storage and retrieval system in FIGS. 11A and 11B and the transport vehicle in FIG. 11C, the locking assembly being in the form of a combination of an electric and mechanical locking assembly for physically preventing that the transport vehicle move relative the second area, where FIGS. 11D and 11E are different views of the locking assembly being in an unlocked state and FIGS. 11F and 11G are different views of the locking assembly being in a locked state.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

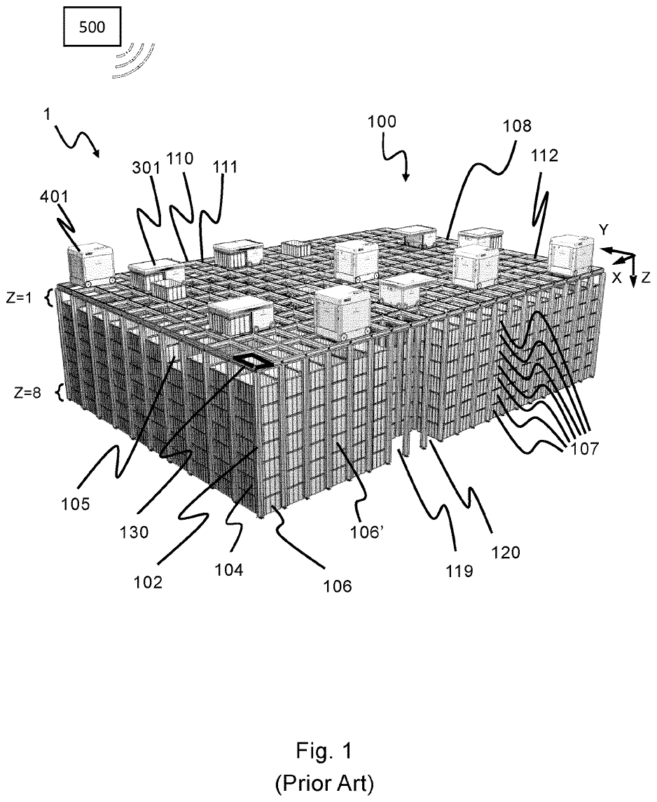

A frame structure 100 of the automated storage and retrieval system 1 may be constructed in a similar manner to the prior art frame structure 100 described above in connection with FIG. 1. That is, the frame structure 100 may comprise a number of upright members 102, and comprise a rail system 108 extending in the first direction (X direction) and the second direction (Y direction). I.e, the rail system 108 may be arranged on top of the upright members 102, the rail system 108 comprising a first set of parallel rails 110 and a second set of parallel rails 111 arranged perpendicular to the first set of rails 110. The first and second set of rails 110,111 providing a horizontal grid-based rail system 108 defining a plurality of grid cells 130. The first and second set of rails 110,111 of the rail system 108 may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell” 130. In arrangements where one direction of rails has only a single track, the grid cell 130 may extend a full rail-width on those sides.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

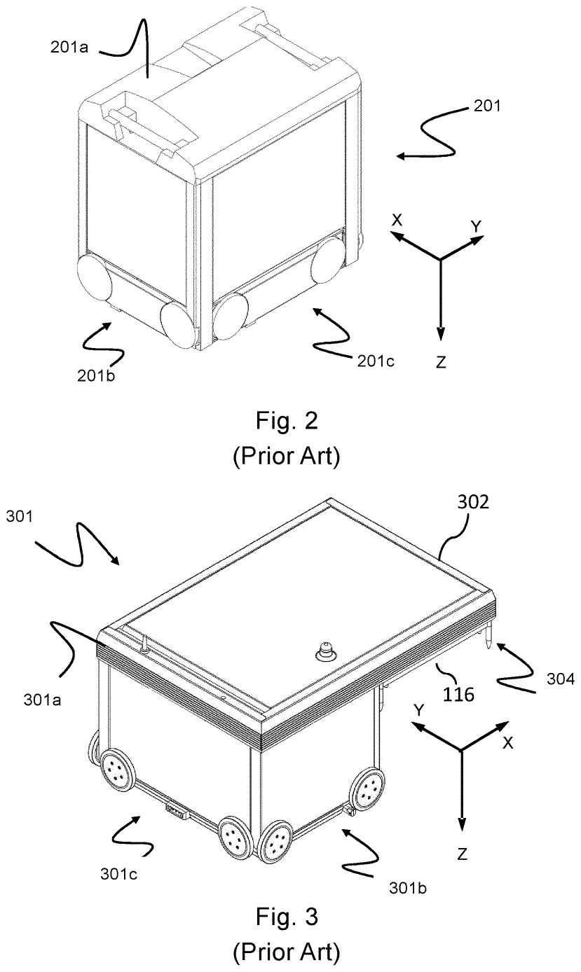

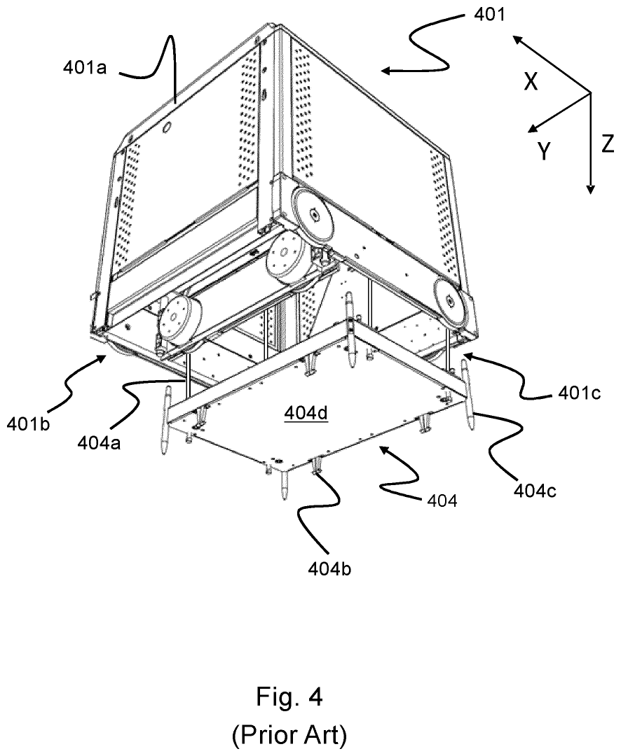

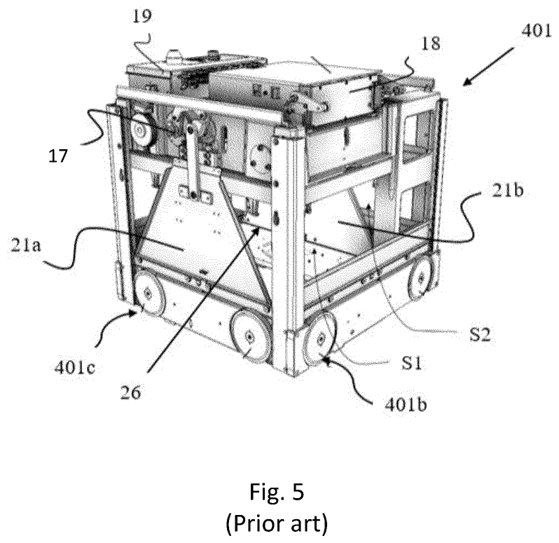

The prior art container handling vehicles comprising a cavity for accommodating a storage container (cavity-type container handling vehicles), see FIGS. 2, 4 and 5, have certain advantageous features. In particular, the guidance/support provided to a storage container when accommodated in the cavity entails that the cavity-type container handling vehicles may have increased acceleration/deceleration relative to the cantilever-type container handling vehicle 301 shown in FIG. 3. However, the potential increase in acceleration/deceleration is not fully realized due to instability of the cavity-type container handling vehicles. The instability is caused by the cavity-type container handling vehicles 201,401 having most of the drive, power, control and lifting components arranged above the cavity, providing a high centre of gravity.

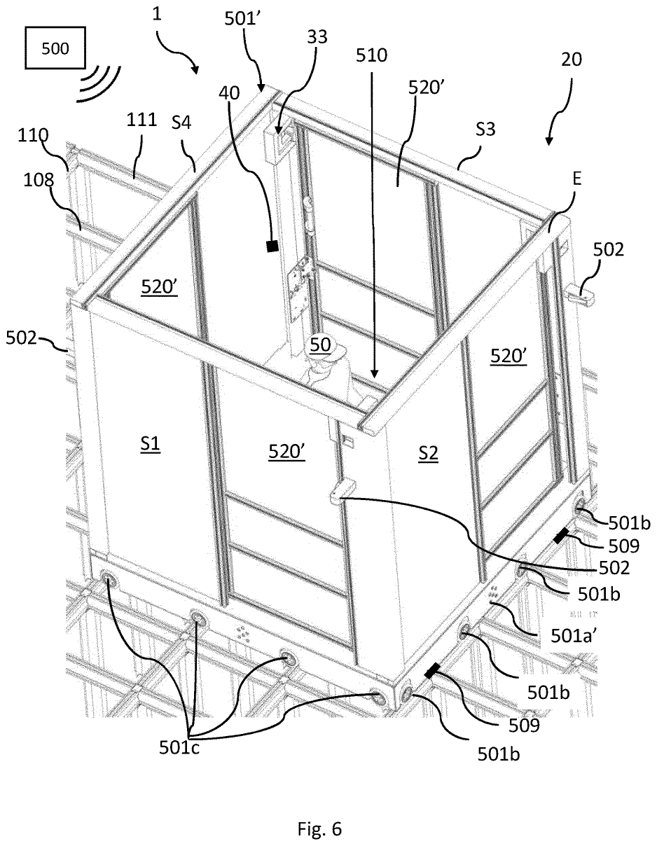

FIG. 6 shows details of an exemplary transport vehicle 501′ for the automated storage and retrieval system 1.

The transport vehicle 501′ vehicle comprises an enclosure E defining an enclosed first area 510 for transporting a person 50 within. The enclosure E is formed by four sides, i.e. first side S1, second sideS2, third side S3 and fourth side S4. In the example in FIG. 6 there is arranged one lockable barrier 520′ configured to provide access for a person into the first area 510 on each of the four sides S1,S2,S3,S4 such that the transport vehicle 501′ can connect to a second area 30 arranged on any of the four sides S1,S2,S3,S4.

The transport vehicle 501′ features a vehicle body 501a′. A first set of wheels 501b for driving in the first direction X and a second set of wheels 501c for driving in the second direction Y are arranged on the vehicle body 501a′.

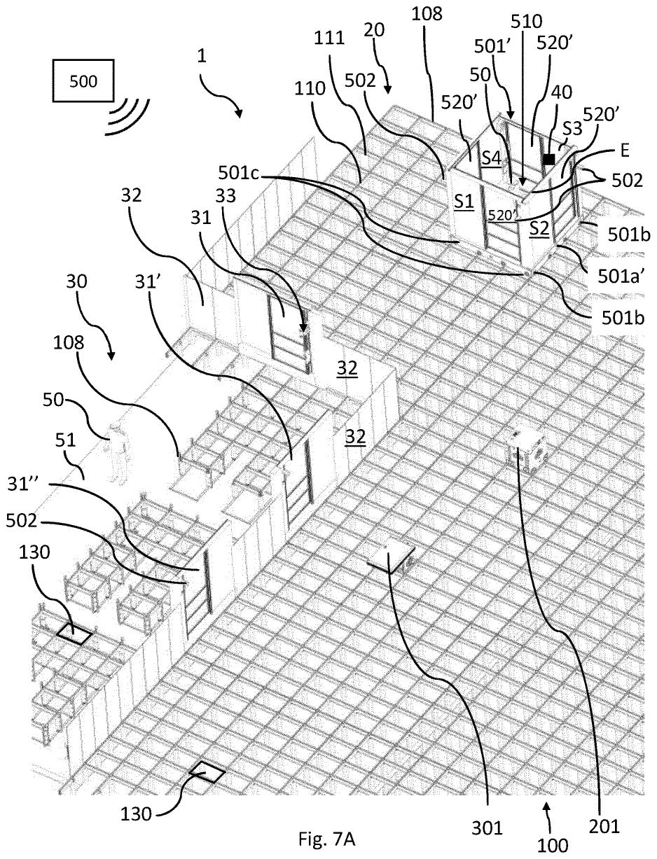

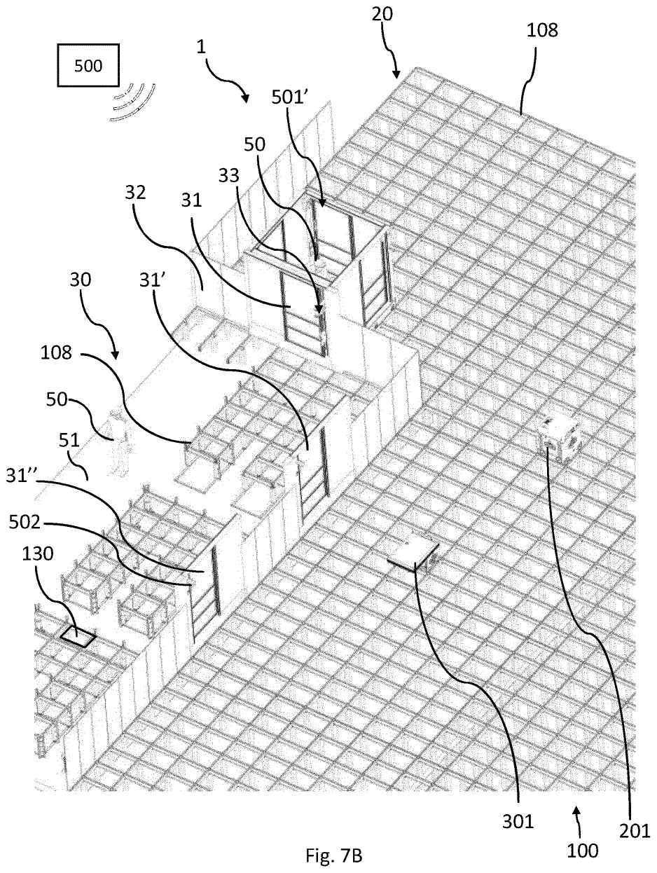

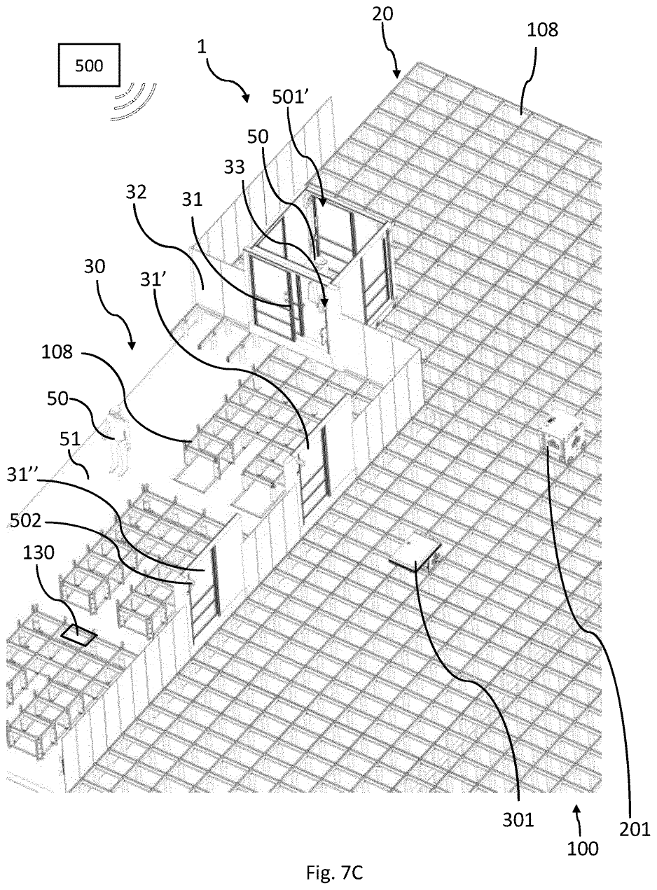

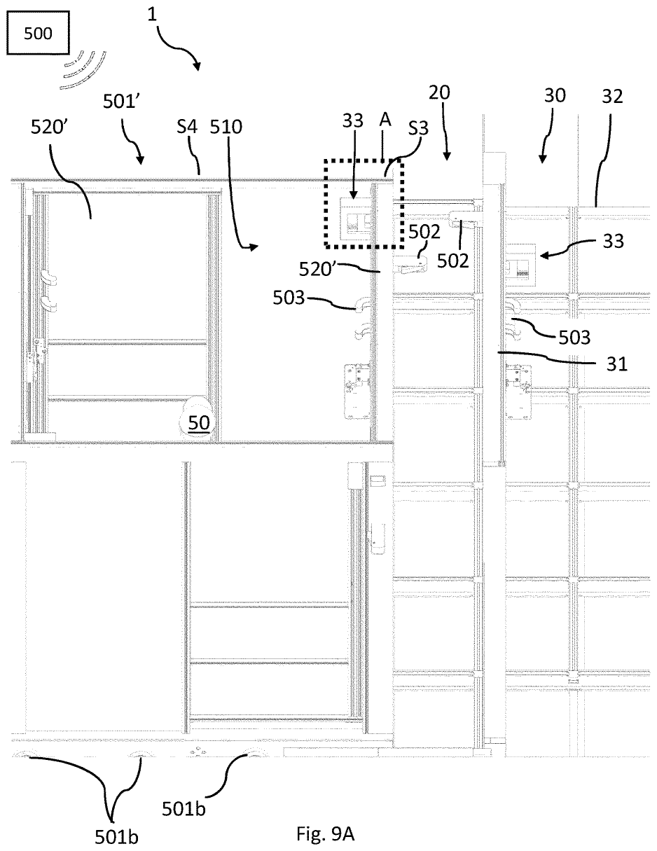

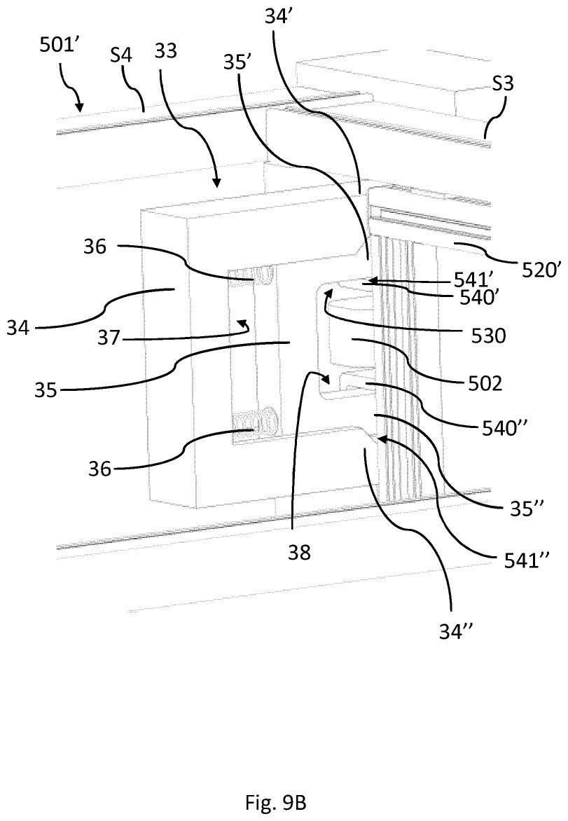

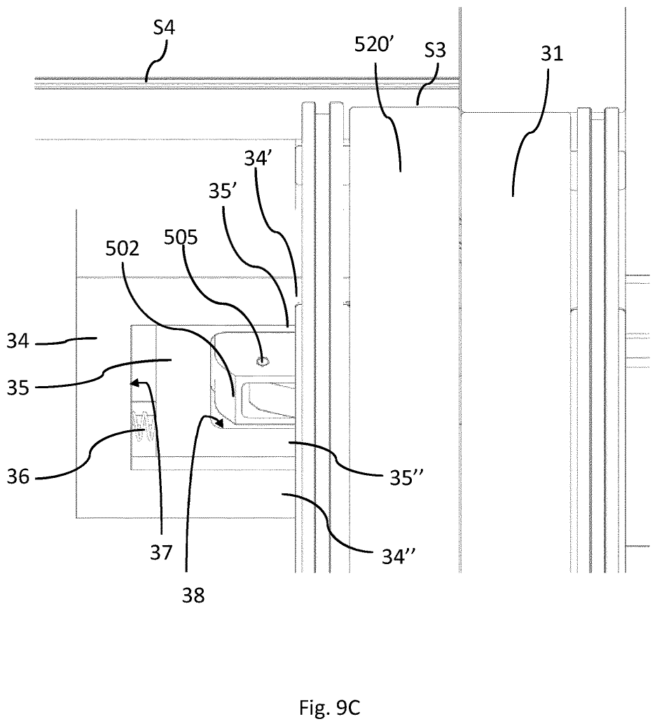

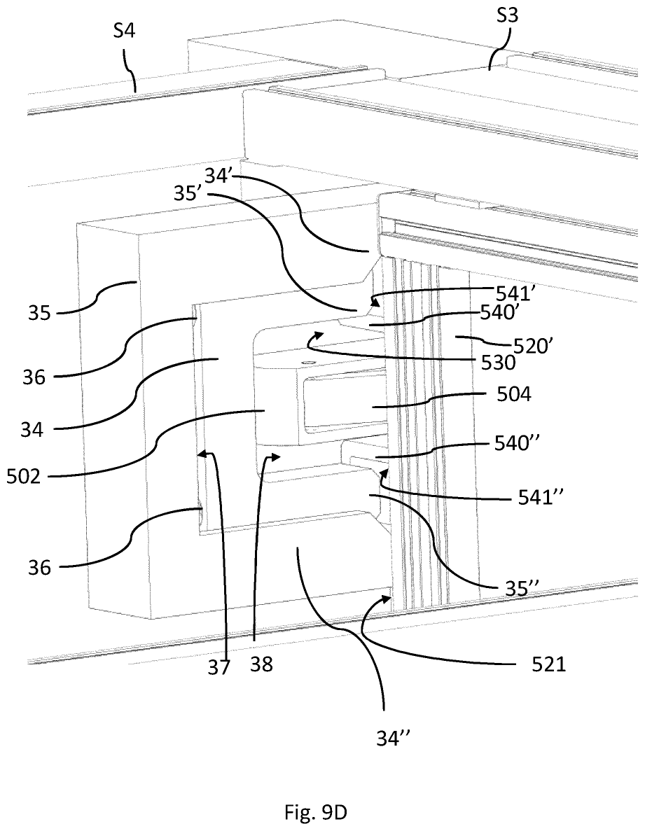

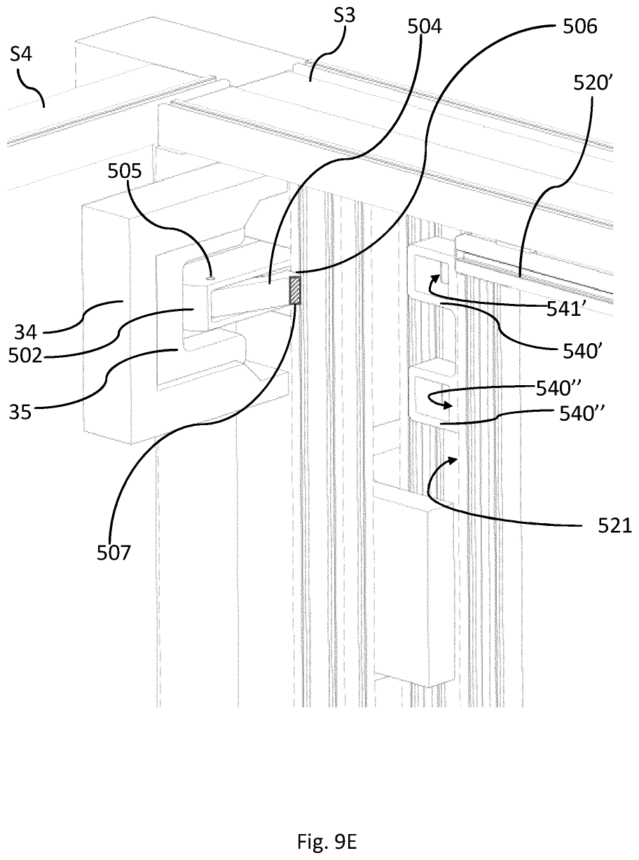

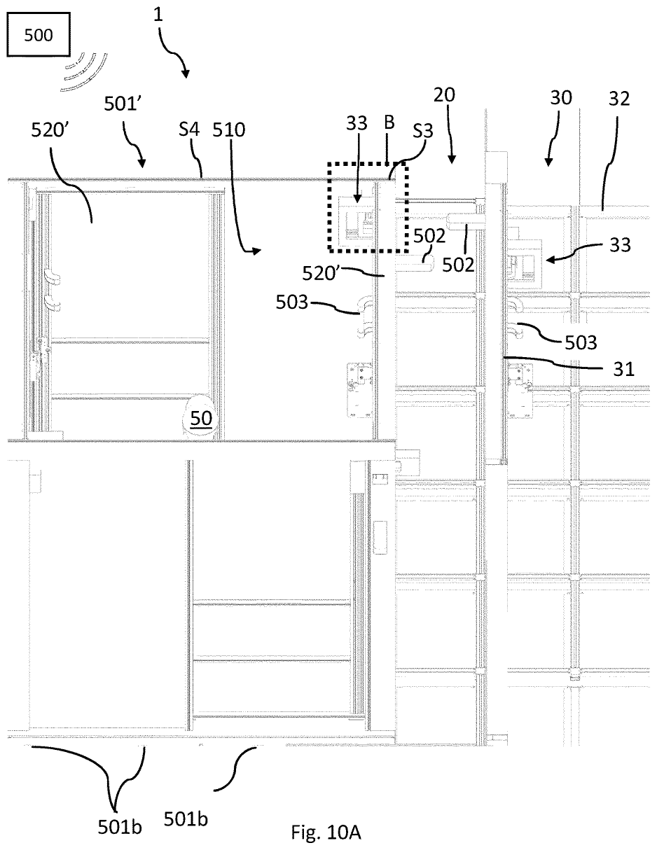

The shown transport vehicle 501′ features a docking probe 502 on each side S1,S2,S3,S4 (only three of the docking probes 502 shown in FIG. 6) for interaction with a locking assembly 33 positioned in proximity of each barrier 31,31′,31″ along the wall 32 (see e.g. FIG. 7A). Different examples of the interaction between the docking probe 502 and the locking assembly 33 will be illustrated and explained below with reference to FIGS. 9A-9E and FIGS. 10A-10F.

As shown on the wall 32 (see e.g. FIG. 7A), in order to further lock the transport vehicle 501′ to the wall 32 between the operating area 20 and the second area 30, a docking probe 502 may be arranged on the wall 32 and the transport vehicle 501′ may in addition comprise a locking assembly (not shown).

Although not shown, the transport vehicle 501′ preferably comprises a wheel lift mechanism operable between a first position in which the first set of wheels 501b is above the second set of wheels 501c such that the second set of wheels 501c is in contact with the rail system 108, and a second position in which the first set of wheels 501b is below the second set of wheels 501c such that the first set of wheels 501b is in contact with the rail system 108.

Furthermore, although not shown, the transport vehicle 501′ preferably comprises a wheel drive motor for driving the first set of wheels 501b and/or the second set of wheels 501c for moving the transport vehicle 501′ on the rail system.

The transport vehicle 501′ is preferably in communication with the control system 500 such that the control system 500 gives instructions to the transport vehicle 501′ where to move within the operating area 20 of the rail system 108 without the risk of collision with the container handling vehicles 201,301,501.

The transport vehicle 501 may further comprise an emergency stop 40. The emergency stop 40 may comprise a transmitter configured to transmit an emergency stop signal to the control system 500. For example, the emergency stop may comprise a transmitter and the control system 500 may comprise a receiver for receiving a signal from the transmitter. The control system may then send stop signal to all container handling vehicles and transport vehicles or it may cut the power.

The transport vehicle 501′ may comprise one or more supports 509 for stabilizing the transport vehicle 501′. The support 509 is movable between a raised position where it is lifted from the rail system 108 and a lowered position where it is in contact with the rail system 108. The support 509 is preferably configured to interact with the rail system 108. The support 509 may interact with the rail system 108 in order to stabilize the transport vehicle during entering and exit of a person.

The support 509 may be used in addition to lowering all wheels into contact with the rail system 108 during entering and exit of a person 50. It may also provide for additional support which may be required when bringing container handling vehicles 201,301,401, tools etc. into or out of the first area 510 of the transport vehicle 501′.

FIG. 7A shows a perspective view of an automated storage and retrieval system 1 comprising a rail system 108 with an operating area 20, a second area 30 in the form of a safe area partitioned from the operating area 20, and a transport vehicle 501′ which moves on the rail system 108.

The disclosed transport vehicle 501′ in FIG. 7A has a footprint on the rail system 108 which covers a total of 12 grid cells 130 (4 grid cells in the first direction X and 3 cells in the second direction Y). The control system 500 will then typically take into account the total size of the footprint of the transport vehicle 501′ when providing routing instructions both to the transport vehicle 501′ and to all of the container handling vehicles 201,301,401 within the operating area 20.

In the operating area 20 it is disclosed two container handling vehicles 201,301 and one transport vehicle 501′. Although only two container handling vehicles 201,301 and one transport vehicle 501′ are shown, it is clear that multiple container handling vehicles 201,301,401 may be within the operating area 20. There may also be more than one transport vehicle 501′ within the operating area 20.

In the example in FIGS. 7A-7C, the rail system 108 extends into the second area 30 such that the container handling vehicles 201, 301 can move between the operating area 20 and the second area 30 by moving on the rail system 108. The second area 30 is partitioned or separated from the operating area 20 by a physical wall 32 or fence which physically prevents that the container handling vehicles 201,301 and the transport vehicle 501′ can enter the second area 30 unintentionally.

A number of barriers 31,31′,31″ are arranged at strategic positions along the wall 32 for providing access points for the container handling vehicles 201,301 between the operating area 20 and the second area 30. The second area 30 in FIGS. 7A-7C is a safe area where persons or operators 50 can perform maintenance or repair on the container handling vehicles 201,301. In order to ensure that the second area 30 is a safe area, the container handling vehicles 201,301 are normally shut down when in the second area 30 to avoid harm or injury to the operators. The second area 30 is disclosed with a floor 51 for the operators 50 to walk freely. The rail system 108 in the second area 30 is preferably shallow, i.e. the rails 110,111 are either positioned directly on the floor 51 or they are arranged in a relatively low height (typically less than 50 cm) above the floor 51 to ease movement for the operator 50 on the rails 110,111 or between the grid cells 130 formed by the rails 110,111.

The barriers 31,31′,31″ are in the form of lockable sliding doors which in FIG. 7A all of the barriers 31,31′,31″ are locked.

The second area 30 may comprise an emergency stop 40 with similar features and functions as the emergency stop 40 of the transport vehicle 501′.

As shown in FIG. 7A, a person 50 is transported by the transport vehicle 501′. When the person 50 is within the first area 510 of the transport vehicle 501′, the person is physically protected from the container handling vehicles 201,301,401 operating in the operating area 20. The person 50 enters and exits the first area 510 through any of the lockable barriers 520′ when the lockable barriers 520′ are unlocked allowing passage therethrough.

FIG. 7B is a similar view as in FIG. 7A, but in FIG. 7B the transport vehicle 501′ has moved to a position next to the second area 30 such that one of the lockable barriers 520′ of the transport vehicle 501′ is positioned in front of a lockable barrier 31 of the second area 30. However, the transport vehicle 501′ is allowed to move relative the second area 30 since the barriers 520′,31 are locked.

As indicated above, the transport vehicle 501′ is preferably configured to receive routing instructions from the control system 500. When a person 50 shall enter or exit the first area 510, such routing instructions may be to the position next to the barrier 31 of the second area 30 as illustrated in FIG. 7B (and FIG. 7C).

FIG. 7C is a similar view of FIG. 7B, but in FIG. 7C the lockable barrier 520′ of the transport vehicle 501′ and the lockable barrier 31 of the second area 30 are unlocked because movement of the transport vehicle 501′ relative to the second area 30 is physically prevented.

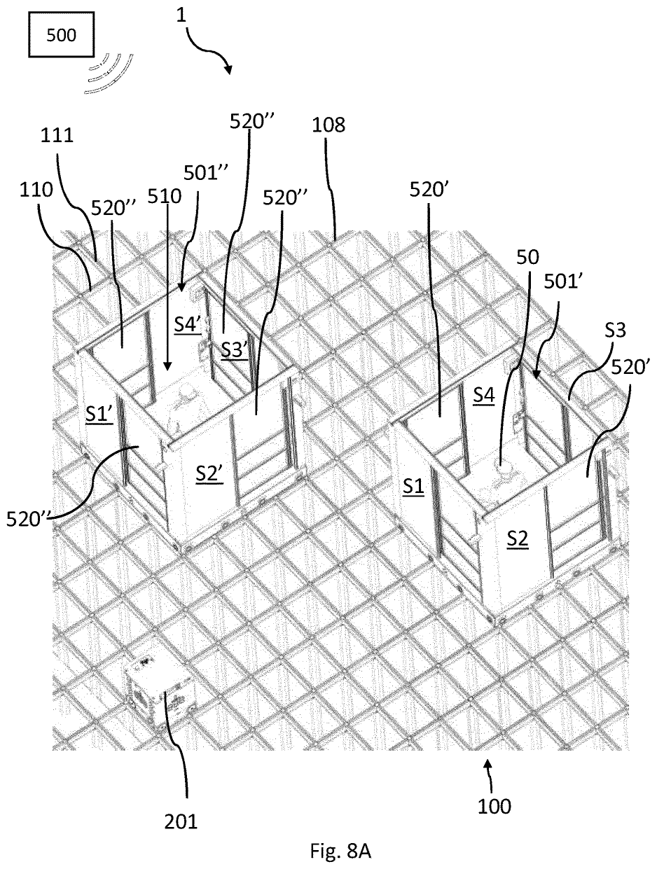

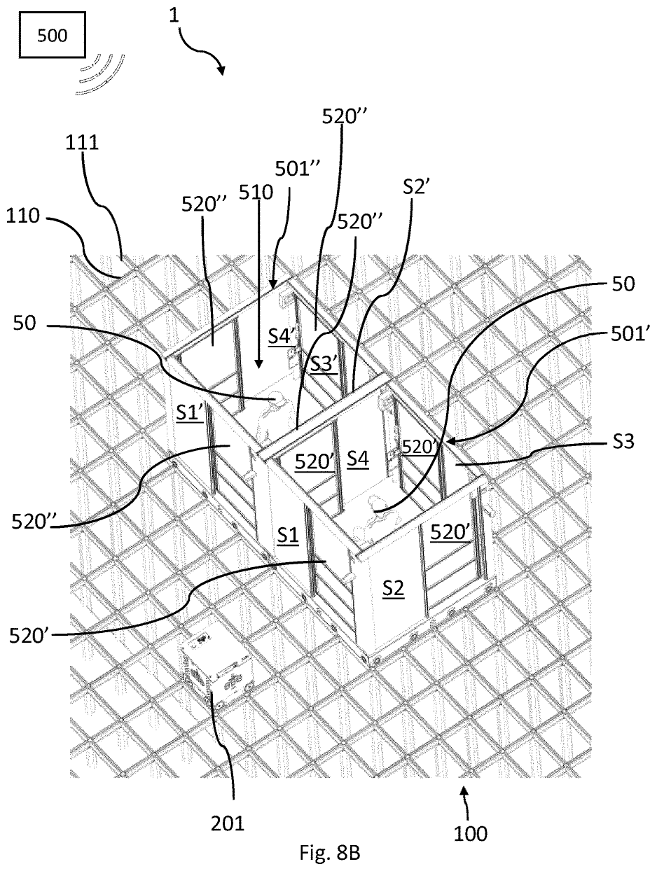

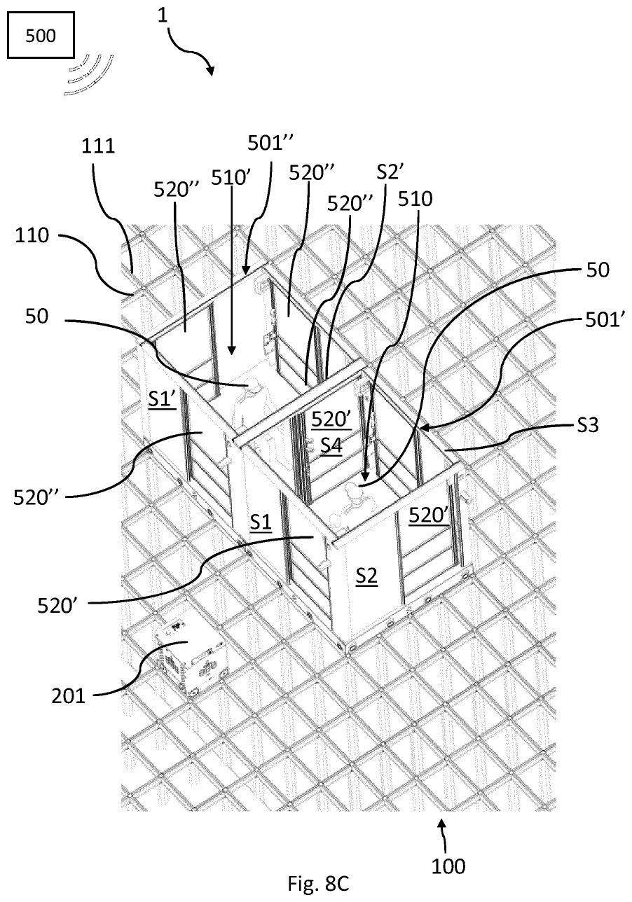

FIG. 8A shows a perspective view of an automated storage and retrieval system 1 comprising a rail system 108 with an operating area 20, two transport vehicles 501′,501″ within the operating area 20. Both of the transport vehicles 501′,501″ are identical to the transport vehicle 501′ shown in detail on FIG. 6, thus some of the details have been omitted on purpose to better illustrate the cooperation of the transport vehicles 501′,501″. The second area 510′ in this example is thus in a second transport vehicle 501″. In some situations, it may be required to transfer a person from the transport vehicle 501′ to the second transport vehicle 501″. Such situations may e.g. be if the transport vehicle 501′ malfunctions or if a person shall be transported over large distances using the second transport vehicle 501″. The second transport vehicle 501″ may be identical to the transport vehicle 501′ or it may be a container handling vehicle with sufficient space for a person to enter into or onto it.

In FIG. 8A the transport vehicles 501′,501″ are arranged at a distance from each other and there is arranged one person 50 in each of the transport vehicles 501′,501″. All of the four lockable barriers 520′ of the transport vehicle 501′ are locked. Similarly, all of the four lockable barriers 520″ of the second transport vehicle 501″ are locked.

FIG. 8B is a similar view as in FIG. 8A where the first and a second transport vehicles 501′,501″ and the barriers 520′,520″ are in theory unlocked such that the doors can be open, however the transport vehicles 501′,501″ are not locked to each other since none of the doors has been opened.

As seen in FIG. 8B, the transport vehicles the lockable barrier 520′ on the fourth side S4 of the transport vehicle 501′ is positioned next to the lockable barrier 520″ on the second side S2′ of the second transport vehicle 501″.

FIG. 8C is a similar view as in FIG. 8B with the transport vehicles 501′,501′ positioned next to each other and the barriers 520′,520″ are unlocked, but since the doors 520′,520″ have been opened the transport vehicles 501′,501″ are locked to each other. The sliding doors in each of the enclosures of the first and second areas 510,510′ are open making it possible for a person 50 to pass from one vehicle 501′,501″ to the other vehicle 501″,501′. It can be clearly seen that the person 50 in the second transport vehicle 501″ is visible through the unlocked barriers 520′,520″.

In FIGS. 8A-8C each of transport vehicles 501′,501″ comprises both a docking probe 502 and a locking assembly 33. Components which will be described in greater detail with reference to Figs. FIGS. 9A-9E and 10A-10F.

Common to both the example in FIGS. 7A-7C and 8A-8C, when the transport vehicle 501′ is at the position next to the barrier 31 of the second area 30 (as in FIGS. 7B and 7C) or next to the second transport vehicle 501″ (as in FIGS. 8B and 8C), the wheels in the first and second set of wheels 501b,501c may be lowered to the same level such that all of the wheels of the transport vehicle 501′ are in contact with the underlying rails 110,111 of the rail system 108. When all wheels are in contact with the underlying rails 110,111, stability of the transport vehicle 501′ is greatly improved since the risk that the transport vehicle 501′ rolls uncontrolled in any direction is eliminated. Furthermore, as an alternative or in addition to lowering all wheels to the same level, the transport vehicle 501′ may comprise a support 509 as described in relation to FIG. 6 above.

### First Example of a Mechanical Locking Assembly 33, FIGS. 9A-9E

FIGS. 9A-9E show different steps of a locking sequence of a first example of a mechanical locking assembly 33 for physically preventing that the transport vehicle 501′ move relative the second area 30,510′. The mechanical locking assembly 33 is the same regardless of whether the second area 30 is a safe area 30 where persons or operators 50 can perform maintenance or repair on the container handling vehicles 201,301,401 as exemplified in FIGS. 7A-7C or if the second area 510′ is in a second transport vehicle 501″ as exemplified in FIGS. 8A-8C. However, in the illustrated example in FIGS. 9A-9E, the second area 30 is a safe area. The features of the transport vehicle 501′ is the same as the transport vehicle 501′ of FIG. 6.

FIG. 9A is a perspective view of a transport vehicle 501′ within an operating area 20 approaching a wall 32 with a barrier 31 of the second area 30. A person 50 is positioned within the first area 510 of the transport vehicle 501′. The lockable barriers 520′ of the transport vehicle 501′ are in the form of sliding doors, where each door comprises a handle 503 to ease opening and closing of the doors.

The transport vehicle 501′ is shown with a docking probe 502 on an outer surface of the third side S3 facing the barrier 31 of the second area 30. The docking probe 502 is oriented outwardly towards the second area 30 and at the same height as a locking assembly 33 on the wall 32 next to the lockable barrier 31 of the second area 30. Similarly, in order to further lock the transport vehicle 501′ to the wall 32 between the operating area 20 and the second area 30, a docking probe 502 is arranged on the wall 32 next to the barrier 31 and the transport vehicle 501′ has a locking assembly 33 at the same height as the docking probe 502. The docking probe 502 is shaped to cooperate with the locking assembly 33 to provide a safe interconnection therebetween with minimum risk of unintentional disengagement of the transport vehicle 501′ when it is locked to the second are by the lockable barriers 31,520′.

FIG. 9B is an enlarged view of section A in FIG. 9A showing details of the locking assembly 33 when the lockable barrier 520′ is locked preventing movement of the transport vehicle 501′. The locking assembly 33 comprising an outer member 34 having a U-shape forming a receiving portion 37 of the outer member 34. The two ends (indicated as outer upper end 34′ and outer lower end 34″) are securely connected to the inside of the third side S3 of the enclosure E of the transport vehicle 501′. The locking assembly 33 further comprising an inner member 35 movable within the receiving portion 37 of the outer member 34. The inner member 35 having a U-shape forming a receiving portion 38 of the inner member 35 oriented in the same direction as the outer member 34. The U-shape of the inner member 35 has an upper end 35′ and lower end 35″. The inner member 35 is connected to the outer member 34 by pretension springs 36 which exert a force on the inner member in a direction towards the third side S3. The lockable barrier 520′ comprises lock members 540′,540″. The lock members 540′,540″ protrude sideways as an extension of the barrier 520′ and each comprises an opening 541′,541″ (see details in FIGS. 9D and 9E) such that each of the lock member 540′,540″ is configured to receive the respective upper end 35′ and lower end 35″ of the inner member 35 such that the barrier is locked when the inner member 35 is in the extended position as shown in FIG. 9B.

The third side S3 has a hole 530 of sufficient size to allow passage of the docking probe 502 which is arranged on the wall 32. The hole 530 is flush with the receiving portion 38 of the inner member 35.

In FIG. 9C, the transport vehicle 501′ has moved somewhat closer to the lockable barrier 31 in the wall 32. This can be seen when comparing the extension of the docking probe 502 in the receiving portion 38 of the inner member 35.

In FIG. 9D, the transport vehicle 501′ has moved somewhat even closer to the lockable barrier 31 in the wall 32. This can be seen when comparing the extension of the docking probe 502 in the receiving portion 38 of the inner member 35. In addition, the docking probe 502 pushes towards an inner part of inner member 35 against the pretension force of the springs 36. As seen in FIG. 9D, the springs 36 have been compressed, which involves that the ends 35′,35″ of the inner member 35 are moved out of the locking relationship with the openings 541′,541″ of the lock member 540′,540″.

As seen in FIG. 9D (and FIG. 9E) the docking probe 502 comprises pretensioned latching mechanism 504 which is pivotably arranged at pivot point 505 inside the docking probe 502. The pretension of the latching mechanism 504 may be a spring or similar. When an outer force is not exerted on the latching mechanism 504 (see. FIG. 9E), the latching mechanism is in an extended position where it extends sideways beyond an outer periphery of the docking probe 502 (when seen from above). And when an outer force is exerted on the latching mechanism 504 (see FIG. 9D), the pretensioned force is overcome and the latching mechanism 504 is forced to a retracted position inside an outer periphery of the docking probe 502 (when seen from above). The difference between the extended position of the latching mechanism 504 and the retracted position of the latching mechanism 504 is illustrated by comparing the relative positions of the latching mechanism 504 in FIG. 9D (retracted) and FIG. 9E (extended).

Referring to FIG. 9D again, the barrier 520′ is now in theory unlocked. This means that the barrier 520′ is allowed to slide open (to the right in the Figure). However, the final locking step which prevents movement of the transport vehicle 501′ relative the wall 32 by using the latching mechanism 504 is not activated because the end face 521 of the barrier 520′ forces the latching mechanism 504 to the retracted position.

Referring to FIG. 9E, the barrier 520′ has been moved to the right and, since the end face of the barrier 520′ is no longer in contact with the latching mechanism 504 forcing it to the retracted position, the pretension of the latching mechanism 504 is released forcing the latching mechanism 504 outwardly. The sketched area 507 of the latching mechanism 504 illustrates the area which is in contact with the end face 521 of the barrier 520′.

A back end 506 of the latching mechanism 504 is abutting the inside of the third side S3.

When the barrier 520′ shall be moved back from unlocked where movement of the transport vehicle 501′ is prevented (FIG. 9E) and to locked where movement of the transport vehicle 501′ is allowed relative to the second area 30;510′, the described sequence in FIGS. 9A-9E is performed in reverse order. The sequence may then involve, in simplified steps:
Moving the barrier 520′ to the left thereby closing the barrier 520′ and forcing the latching mechanism 504 to the retracted position due to contact with the end face 521 of the barrier 520′;
Optional: lifting or lowering the first set of wheels 501b or the second set of wheels 501c;
Moving the transport vehicle 501′ away.

### Second Example of a Mechanical Locking Assembly 33, FIGS. 10A-10F

FIGS. 10A-10F show different steps of a locking sequence of a second example of a mechanical locking assembly 33 for physically preventing that the transport vehicle 501′ move relative the second area 30,510′. The mechanical locking assembly 33 is the same regardless of whether the second area 30 is a safe area 30 where persons or operators 50 can perform maintenance or repair on the container handling vehicles 201,301,401 as exemplified in FIGS. 7A-7C or if the second area 510′ is in a second transport vehicle 501″ as exemplified in FIGS. 8A-8C. However, in the illustrated example in FIGS. 10A-10F, the second area 30 is a safe area. The features of the transport vehicle 501′ is the same as the transport vehicle 501′ of FIG. 6.

FIG. 10A is a perspective view of a transport vehicle 501′ within an operating area 20 approaching a wall 32 with the barrier 31 of the second area 30. A person 50 is positioned within the first area 510 of the transport vehicle 501′. The lockable barriers 520′ of the vehicle 501′ are in the form of sliding doors, where each door comprises a handle 503 to ease opening and closing of the barriers 520′ (doors).

The transport vehicle 501′ is shown with a docking probe 502 on an outer surface of the third side S3 facing the barrier 31 of the second area 30. The docking probe 502 is oriented outwardly towards the second area 30 and at the same height as a locking assembly 33 on the wall 32 next to the lockable barrier 31 of the second area 30. Similarly, in order to further lock the transport vehicle 501′ to the wall 32 between the operating area 20 and the second area 30, a docking probe 502 is arranged on the wall 32 next to the barrier 31 and the transport vehicle 501′ has a locking assembly 33 at the same height as the docking probe 502. The docking probe 502 is shaped to cooperate with the locking assembly 33 to provide a safe interconnection therebetween with minimum risk of unintentional disengagement of the transport vehicle 501′ when it is locked to the second area by the lockable barriers 31,520′.

FIG. 10B is an enlarged view of section B in FIG. 10A showing details of the locking assembly 33 when the lockable barrier 520′ is locked preventing movement of the transport vehicle 501′. The locking assembly 33 comprising an outer member 34 having a U-shape forming a receiving portion 37 of the outer member 34. The two ends (indicated as outer upper end 34′ and outer lower end 34″) are securely connected to the inside of the third side S3 of the enclosure E of the transport vehicle 501′. The locking assembly 33 further comprising an inner member 35 movable within the receiving portion 37 of the outer member 34. The inner member 35 having a U-shape forming a receiving portion 38 of the inner member 35 oriented in the same direction as the outer member 34. The U-shape of the inner member 35 has an upper end 35′ and lower end 35″. The inner member 35 is connected to the outer member 34 by pretension springs 36 which exert a force on the inner member in a direction towards the third side S3. The portion of the inner member 35 which is in contact with the springs 36 has an upper part 35′″ with a first thickness T1 and a lower part 35″″ with a second thickness T2. The first thickness T1 is thicker than the second thickness T2 (T1>T2).

The lockable barrier 520′ comprises lock members 540′,540″. The lock members 540′,540″ protrude sideways as an extension of the barrier 520′ and each comprises an opening 541′,541″ (see details in FIGS. 10D-10F) such that each of the lock member 540′,540″ is configured to receive the respective upper end 35′ and lower end 35″ of the inner member 35 such that the barrier is locked when the inner member 35 is in the extended position as shown in FIG. 10B.

The third side S3 has a hole 530 of sufficient size to allow passage of the docking probe 502 which is arranged on the wall 32. The hole 530 is flush with the receiving portion 38 of the inner member 35.

In FIG. 10C, the transport vehicle 501′ has moved close to the lockable barrier 31 in the wall 32. This can be seen when comparing the extension of the docking probe 502 in the receiving portion 38 of the inner member 35. The docking probe 502 is in contact with the lower part 35″″ of the inner member 35.

In FIG. 10D, the transport vehicle 501′ and thus the locking assembly 33 has been lowered relative the wall 32 and thus the docking probe 502. The lowering can be performed by using a track shift or wheel lift mechanism of the transport vehicle 501′ to lower the transport vehicle 501′ such that all of the wheels in both the first set of wheels 501b and the second set of wheels 501c are in contact with the rails 110,111. The lowering is visible when comparing the position fog the docking probe 502 relative the upper part 35′″ and the lower part 35″″ of the inner member 35. In FIG. 10D, the docking probe 502 is in contact with the upper part 35′″ whereas in FIG. 10C the docking probe 502 is in contact with the lower part 35″″. As a result that the docking probe 502 is in contact with the upper part 35′″ which has larger thickness T1 than the lower part T2 (see FIG. 10B), the springs 36 connecting the inner member 35 to the outer member 24 are compressed which involves that the ends 35′,35″ of the inner member 35 are moved out of the locking relationship with the openings 541′,541″ of the lock member 540′,540″. The barrier 520′ is now in theory unlocked. This means that the barrier 520′ is allowed to slide open (to the right in the Figure).

However, the final locking step which prevents movement of the transport vehicle 501′ relative the wall 32 has not been activated. This locking step will be described with reference to FIGS. 10E and 10F below.

Referring to FIG. 10E, it is disclosed a push member 508 at the end portion of the barrier 520′ closest to the locking assembly 33. The push member 508 follows the movement of the barrier 520′. The push member 508 is configured to exert a force on a locking member 511. The locking member 511 is connected to the third side S3 of the transport vehicle 501′ on the opposite side of the locking assembly 33 compared to the push member 508. The locking member 511 can be pretensioned by for example a lock spring 512. As illustrated, the locking member 511 and the push member 508 can come into contact above the docking probe 502. The locking member 511 has a wedge member 513 arranged at or below a lowermost elevation of the docking probe 502 such that when the barrier 520′ is locked, the wedge member is arranged to the side of the docking probe 502 and cannot influence vertical movement of the locking assembly 33 relative the docking probe 502 (see FIG. 10D), and when the barrier 520′ is unlocked, the wedge member 513 is arranged between the docking probe 502 and the inner member 35 such that it prevents relative vertical movement of the locking assembly 33 relative the docking probe 502 (see FIG. 10E). As such, when the transport vehicle 501′ is lowered with all wheels in contact with the rails 110,111 and the barrier is unlocked 520′, it is not possible to raise any of the sets of wheels 501b,501c since the vertical upward movement of the locking assembly 33 relative the docking prove 502 is prevented.

The relationship between the push member 508 and the locking member 511 is such that when the barrier 520′ is closed, i.e. the position shown in FIG. 10D, the push member 508 overcomes the force of the lock spring 512 and locking member 511 is to the left of the docking probe 502 in FIG. 10E. And, when all wheels of the transport vehicle 501′ are in contact with the rails 110,111 the barrier 520′ is unlocked and the push member 508 can be moved to the right (see FIG. 10E) together with the barrier 520′ and out of contact with the locking member 511. The force from the lock spring 512 will then push the locking member 511 towards the docking probe 502 and the wedge member 513 will move into the space below the docking probe 502 and above the inner member 35.

FIG. 10F shows the same unlocked state of the barrier 520′ with the barrier 520′ moved to the right from a different angle.

When the barrier 520′ shall be moved back from unlocked where movement of the transport vehicle 501′ is prevented (FIGS. 10E and 10F) and to locked where movement of the transport vehicle 501′ is allowed relative to the second area 30; 510′, the described sequence in FIGS. 10A-10E/F is performed in reverse order.

The sequence may then involve, in simplified steps:
Moving the barrier 520′ to the left thereby closing the barrier 520′ and forcing the locking member 511, and thus the wedge member 513, to the left out of contact with the docking probe 502 due to contact with push member 508 on the barrier 520′;
Lifting the first set of wheels 501b or the second set of wheels 501c;
Moving the transport vehicle 501′ away.

### Third Example, Combination of Electric and Mechanical Locking Assembly 33 FIGS. 11A-11G

FIG. 11A is a side view of a second example of a transport vehicle 501′ with a locking assembly in the form of a combination of an electric and mechanical locking assembly 60. The transport vehicle 501′ in FIG. 1.1A has many features in common with the exemplary transport vehicle in FIG. 6, which common features will not be repeated herein. However, instead of the mechanical locking assembly 33 and docking probe 502 in the example on FIG. 6, a combination of an electric and mechanical locking assembly 60 is used. The locking assemblies 60 are arranged on the vehicle base 501a of the transport vehicle 501′. Details of the combination of an electric and mechanical locking assembly 60 are described with reference to FIGS. 11D-G. The locking assemblies 60 in FIG. 11A are in an unlocked state and are preferably configured to, when in the unlocked state, inside or flush with an outer periphery of the vehicle base 501a of the transport vehicle 501′.

FIGS. 11B-11C are a side perspective views of an automated storage and retrieval system 1 comprising a combination of an electric and mechanical locking assembly 60. The automated storage and retrieval system 1 comprising: a rail system 108 which comprises an operating area 20, a container handling vehicle 301 operates on rails 110,111 in the operating area 20, a transport vehicle 501′ operates on the rail system 108 and comprises an enclosure E defining an enclosed first area 510 for transporting a person 50 within. The enclosure E comprising a lockable barrier 520′ configured to provide access for a person 50 into the first area 50, and a second 30 area in the form of a safe area partitioned from the operating area 20 and comprising a lockable barrier 31 configured to provide access for a person 50 into the second area 30 from the first area 510.

In FIG. 11B both of the lockable barriers 520′, 31 are locked preventing access for the person 50 therethrough through a barrier lock 70 locking the barriers 520′,31. This is due to that the locking assembly 60 is in the unlocked state (not shown in FIG. 11B, see e.g. FIGS. 11D and 11E). The barrier lock 70 (such as a magnetic lock or any other suitable lock providing the same function) may communicate with the control system 500 with communication means such as a transmitter and a receiver to receive instructions whether to lock or unlock the barrier lock 70. It is only when the transport vehicle 501′ is physically prevented from movement relative the second area 30 by the barriers 520′,31 that the control system will instruct the barrier lock 70 to open such that safe access through the barriers 520′,31 are ensured. Thus, unless the transport vehicle 501′ is physically prevented from movement relative the second area 30 by the barriers 520′,31, the barrier lock 70 will keep the barriers 520′,31 locked.

In addition, to further increase safety and preventing risk of movement of the transport vehicle 501′ during transfer of the person 50 into and out of the transport vehicle 501′, the transport vehicle 501′ may comprise a local state recognition system where the locking assembly 60 communicates directly with the barrier lock 70 and where the barrier lock 70 only allows unlocking of the barrier 520′,31,510′ when the locking assembly 60 confirms it locked state (where the transport vehicle 501′) is physically prevented from movement relative the second area 30.

When comparing FIG. 11C with FIG. 11B, one can see that both of the lockable barriers 520′, 31 are unlocked and open allowing access for the person 50 therethrough. This is due to that the locking assembly 60 is in the locked state (not shown in FIG. 11B, see e.g. FIGS. 11F and 11G) and the barrier locks 70 allow opening of the barriers 520′,31.

FIGS. 11D-11G are detailed views of a locking sequence of the locking assembly 60 for the automated storage and retrieval system 1 in FIGS. 11A and 11B and the transport vehicle 501′ in FIG. 11C. The locking assembly 60 being in the form of a combination of an electric and mechanical locking assembly 60 for physically preventing that the transport vehicle 501′ move relative the second area 30, where FIGS. 11D and 11E are different views of the locking assembly 60 being in an unlocked state and FIGS. 11F and 11G are different views of the locking assembly 60 being in a locked state.

The locking assembly 60 comprises a first part 60′ and a second part 60″. The first part 60′ can be mounted on the second area and the second part 60″ can be mounted on the transport vehicle 501′. In the illustrated example, the first part 60′ comprises a recess or opening 62. The second part 60″ comprises a pivotable locking arm 63. The pivotable locking arm 63 has the pivot connection in a first end 63′ thereof and comprises a protrusion in a second end 63″ thereof. The protrusion is complementary shaped relative the recess or opening 62 of the first part 60′ such that when the pivotable locking arm 63 pivots from the unlocked state in FIGS. 11D and 11E where a longitudinal axis LA of the locking arm 63 is mainly vertical to the locked state in FIGS. 11F and 11G where a longitudinal axis LA of the locking arm 63 is mainly horizontal, the protrusion in the second end 63″ of the locking arm 63 enters the recess or groove 52 in the first part and physically prevents the transport vehicle 501′ from movement relative the second area 30.

The first part 60′ can comprise a sensor 61 for detecting proximity of the transport vehicle 501′.

Alternatively, the first part 60′ can be mounted on the transport vehicle 501′ and the second part 60″ can be mounted on the second area 30.

As mentioned above, the locking assembly 60 may form part of a local state recognition system where the locking assembly 60 communicates directly with e.g. a barrier lock 70 where the barrier lock 70 only allows unlocking of the barrier 520′,31,510′ when the locking assembly 60 confirms it locked state (where the transport vehicle 501′) is physically prevented from movement relative the second area 30.

It shall be noted that although it has been exemplified a second area in the form of a safe area 30 in FIGS. 11A-11C, it is clear that the second area can also be a second are 510′ in a second transport vehicle 501″ as disclosed e.g. in FIGS. 8A-8C.

Other mechanisms for locking and unlocking of the lockable barriers 31,520′ than described in FIGS. 9A-9E, FIGS. 10A-10F and 11A-11G may be used. For example, a verification device for verifying that the transport vehicle 501′ is at the position next to the second area, may be used. When it is verified that the transport vehicle 501′ is at the position next to the service area and physically prevented from movement relative the second area 30,510′ such that the lockable barrier 520′ on the transport vehicle and the lockable barrier 31;520″ in the second area are unlocked, passage of a person therethrough is allowed, while when the lockable barrier 520′ on the transport vehicle and the lockable barrier 31;520″ in the second area are locked, passage of an operator 50 therethrough is prevented. The verification device may be one or more sensors at or close to the position next to the second area and the one or more sensors may be configured to confirm that the transport vehicle 501′ is at the position.

With reference to FIGS. 6-11, it is further described a method of transporting a person 50 between a first area 510 and a second area 30;510′ of an automated storage and retrieval system 1 as defined above, wherein the method comprising the steps of:
positioning the transport vehicle 501′ at a position next to the second area 30,510′;
locking the transport vehicle 501′ at the position at the second area 30 such that the lockable barrier 520′ on the transport vehicle and the lockable barrier 31;520″ in the second area are unlocked;
the person entering the first area 510 of the transport vehicle through the lockable barriers 520′,31;520″.

The method may further comprise a step of, prior to the person 50 entering the first area 510 of the transport vehicle 501′, a step of:
utilizing a verification device to verify that the transport vehicle 501′ is at the position next to the second area.

When the transport vehicle 501′ is at the position, the method may comprise the steps of:
lowering all wheels of the first set of wheels and the second set of wheels to the rail system 108.

In the preceding description, various features of the embodiments have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

List of reference numbers

| | |
|---|---|
| 1 | Prior art automated storage and retrieval system |
| 20 | Operating area |
| 30 | Second area/service area |
| 31 | Lockable barrier of service area |
| 32 | Wall |
| 33 | Mechanical locking assembly |
| 34 | Outer member |
| 34′, 34″ | Ends of outer member |
| 35 | Inner member |
| 35, 35″ | Ends of inner member |
| 35″′ | Upper part |
| 35″″ | Lower part |
| 36 | Springs |
| 37 | Receiving portion of outer member 34 |
| 38 | Receiving portion of inner member 35 |
| 40 | Emergency stop |
| 50 | Person/operator |
| 51 | Floor |
| 60 | Combination of electric and mechanical locking assembly |
| 60′ | First part of locking assembly 60 |
| 60″ | Second part of locking assembly 60 |
| 61 | Sensor |
| 62 | Recess or opening |
| 63 | Locking arm |
| 63′ | First end of locking arm |
| 63″ | Second end of locking arm |
| 70 | Barrier lock |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 116 | Lifting device |
| 119 | Delivery column |
| 120 | Delivery column |
| 130 | Grid cell |
| 201 | Prior art container handling vehicle |
| 201a | Vehicle body of the container handling vehicle 201 |
| 201b | Drive means/wheel arrangement/first set of wheels in first direction (X) |
| 201c | Drive means/wheel arrangement/second set of wheels in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 302 | Cantilever |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501′ | Transport vehicle |
| 501″ | Second transport vehicle |
| 501a | Vehicle body of the transport vehicle 501′ |
| 501b | First drive means/wheel arrangement/first set of wheels in first direction (X) |
| 501c | Second drive means/wheel arrangement/second set of wheels in second direction (Y) |
| 502 | Docking probe |
| 503 | Handle |
| 504 | Latching mechanism |
| 505 | Pivot point |
| 506 | Back end |
| 507 | Sketched area of latching mechanism |
| 508 | Push member |
| 509 | Support |
| 510 | First area |
| 510′ | Second area in second transport vehicle 501″ |
| 511 | Pretensioned locking member |
| 512 | Lock spring |
| 513 | Wedge member |
| 520′ | Lockable barrier of the transport vehicle 501′ |
| 520″ | Lockable barrier of the second transport vehicle 501′ |
| 521 | End face of barrier |
| 530 | Hole in side |
| 540′, 540″ | Lock members |
| 541′, 541″ | Openings |
| A | Section A |
| B | Section B |
| E | Enclosure |
| LA | Longitudinal axis |
| S1, S2, S3, S4 | First, second, third, fourth sides of enclosure transport vehicle |
| S1′, S2′, S3′, S4′ | First, second, third, fourth sides of enclosure second transport vehicle |
| T1 | First thickness |
| T2 | Second thickness |
| X | First direction |
| Y | Second direction |
| Z | Third direction |

1-35. (canceled)

36. An automated storage and retrieval system comprising:
a rail system comprising a first set of parallel rails extending in a first direction across the top of a frame structure formed by a plurality of upright members, and a second set of parallel rails in a horizontal plane arranged in a second direction perpendicular to the first set of parallel rails, to guide movement of a plurality of container handling vehicles in the first direction and the second direction, and wherein the rail system comprises an operating area for operating said plurality of container handling vehicles on the rails in the operating area;
a transport vehicle movable on the rail system, the transport vehicle comprising an enclosure defining an enclosed first area for transporting a person within, the enclosure comprising a lockable barrier configured to provide access for a person into the first area;
a second area, partitioned from the operating area and comprising a lockable barrier configured to provide access for a person into the second area from the first area;
wherein both lockable barriers are configured to:
unlock when movement of the transport vehicle is physically prevented relative to the second area; and
lock when movement of the transport vehicle is allowed relative to the second area.

37. The automated storage and retrieval system according to claim 36, wherein the barrier of the transport vehicle and the barrier of the second area are fail-safe locked.

38. The automated storage and retrieval system according to claim 36, wherein the transport vehicle comprises a first set of wheels for driving in the first direction and a second set of wheels for driving in the second direction.

39. The automated storage and retrieval system according to claim 38, wherein the transport vehicle comprises a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

40. The automated storage and retrieval system according to claim 38, wherein the transport vehicle comprises a wheel drive motor for driving the first set of wheels and/or the second set of wheels.

41. The automated storage and retrieval system according to claim 36, comprising a locking assembly in the form of a mechanical locking assembly, a combination of an electric and mechanical locking assembly, a magnetic locking assembly or an electro-magnetic locking assembly providing the physical prevention.

42. The automated storage and retrieval system according to claim 41, wherein the locking assembly is configured to lock a docking probe, and wherein:
the locking assembly is arranged at or in the second area and the docking probe extends outwardly from the transport vehicle, or
the locking assembly is arranged at or in the transport vehicle and the docking probe extends outwardly from the second area.

43. The automated storage and retrieval system according to claim 42, wherein the locking assembly comprises:
an outer member has a U-shape forming a receiving portion within the U-shape and wherein an outer upper end and an outer lower end of the outer member are securely connected to an inside of a side which forms the enclosure;
an inner member which is movable within the receiving portion of the outer member, wherein the inner member has a U-shape forming a receiving portion of the inner member oriented in the same direction as the outer member, and wherein the U-shape of the inner member has an upper end and lower end; and
wherein the side comprises a hole which is flush with the receiving portion of the inner member to allow passage of the docking probe therethrough.

44. The automated storage and retrieval system according to claim 43, wherein the inner member is connected to the outer member by a pretension spring or springs which exert a force on the inner member in a direction towards the hole in the side.

45. The automated storage and retrieval system according to claim 44, wherein the lockable barrier comprises lock members which protrude sideways as an extension of the barrier and wherein each of the lock members comprises an opening such that each of the lock member is configured to receive the respective upper end and lower end of the inner member such that the barrier is locked when the inner member is in an extended position.

46. The automated storage and retrieval system according to claim 42, wherein the docking probe comprises a pretensioned latching mechanism which is pivotably arranged at pivot point inside the docking probe.

47. The automated storage and retrieval system according to claim 46, wherein the latching mechanism is configured such that when an outer force from the barrier is not exerted on the latching mechanism, the latching mechanism is in an extended position where it extends sideways beyond an outer periphery of the docking probe, and when the outer force from the barrier is exerted on the latching mechanism, the pretensioned force is overcome and the latching mechanism is forced to a retracted position inside an outer periphery of the docking probe.

48. The automated storage and retrieval system according to claim 47, wherein, when the outer force from the barrier is not exerted on the latching mechanism, a back end of the latching mechanism is configured to abut the side.

49. The automated storage and retrieval system according to claim 43, wherein a portion of the inner member which is in contact with the pretension spring or springs has an upper part with a first thickness (T1) and a lower part with a second thickness (T2), wherein the first thickness (T1) is thicker than the second thickness (T2), and wherein the docking probe is initially in contact with the lower part.

50. The automated storage and retrieval system according to claim 49, wherein, upon vertical downwards movement of the locking assembly relative the docking probe, the docking probe is configured to be in contact with the upper part instead of the lower part thereby compressing the spring or springs which involves that the upper and lower end of the inner member are moved out of a locking relationship with the openings of the lock member.

51. The automated storage and retrieval system according to claim 50, wherein a locking member is connected to the side of the transport vehicle to a side of the locking assembly, the locking member is pretensioned by a lock spring and comprises a wedge member arranged at or below a lowermost elevation of the docking probe such that when the barrier is locked, the wedge member is arranged to the side of the docking probe and cannot influence vertical movement of the locking assembly relative the docking probe, and when the barrier is unlocked, the wedge member is arranged between the docking probe and the inner member such that it prevents relative vertical movement of the locking assembly relative the docking probe thereby preventing that the transport vehicle may move when the barrier is unlocked.

52. The automated storage and retrieval system according to claim 51, wherein the barrier comprises a push member arranged on the opposite side of the locking assembly compared to the locking member, and wherein the push member is configured to exert a force on the locking member to move the wedge member from between the docking probe and the inner member to the side of the docking probe.

53. The automated storage and retrieval system according to claim 36, further comprising a control system for communication with the container handling vehicles and the transport vehicle.

54. The automated storage and retrieval system according to claim 53, wherein the system comprises a locking assembly in the form of a combination of an electric and mechanical locking assembly, wherein the locking assembly comprises a first part and a second part, where the first part is lockable to the second part representing a locked state of the locking assembly and when in the locked state, the locking assembly informs the control system the control system allows unlocking of the barriers.

55. The automated storage and retrieval system according to claim 54, wherein the system comprises a barrier lock locking the barriers.

56. The automated storage and retrieval system according to claim 55, wherein the barrier lock comprises a transmitter and a receiver for communicating with the control system to lock or unlock the barrier lock.

57. The automated storage and retrieval system according to claim 56, wherein the barrier lock comprises a transmitter and a receiver for communicating with the locking assembly forming a local state recognition system, and where the barrier lock only allows unlocking of the barrier when the locking assembly confirms by communication to the barrier lock that it is in its locked state.

58. The automated storage and retrieval system according to claim 53, wherein the transport vehicle comprises an emergency stop, wherein the emergency stop comprises a transmitter configured to transmit an emergency stop signal to the control system.

59. The automated storage and retrieval system according to claim 53, wherein the transport vehicle is configured to receive routing instructions from the control system to a position next to the second area, and when it is verified that the transport vehicle is at the position next to the service area and the lockable barrier on the transport vehicle and the lockable barrier in the second area are unlocked, passage of a person therethrough is allowed, while when the lockable barrier on the transport vehicle and the lockable barrier in the second area are locked, passage of an operator therethrough is prevented.

60. The automated storage and retrieval system according to claim 59, wherein the control system comprises a verification device for verifying that the transport vehicle is at the position next to the second area.

61. The automated storage and retrieval system according to claim 60, wherein the verification device is one or more sensors at or close to the position next to the second area and wherein the one or more sensors are configured to confirm that the transport vehicle is at the position.

62. The automated storage and retrieval system according to claim 36, wherein the transport vehicle comprises a support for stabilizing the transport vehicle.

63. The automated storage and retrieval system according to claim 62, wherein the support is movable between a raised position where it is lifted from the rail system and a lowered position where it is in contact with the rail system.

64. The automated storage and retrieval system according to claim 36, wherein the second area is a safe area for performing service on the container handling vehicles and where the container handling vehicles are prevented from self-movement.

65. The automated storage and retrieval system according to claim 36, wherein the second area is a temporary area within the operating area.

66. The automated storage and retrieval system according to claim 36, wherein the system comprises a second transport vehicle, wherein the second transport vehicle also comprises an enclosure defining an enclosed second area for transporting a person within.

67. A method of transporting a person between a first area and a second area of an automated storage and retrieval system according to claim 36, wherein the method comprises the steps of:
positioning the transport vehicle at a position next to the second area;
locking the transport vehicle at the position at the second area such that the lockable barrier on the transport vehicle and the lockable barrier in the second area are unlocked;
the person entering the first area of the transport vehicle through the lockable barriers.

68. The method according to claim 67, wherein the method comprises, prior to the person entering the first area of the transport vehicle, a step of:
utilizing a verification device to verify that the transport vehicle is at the position next to the second area.

69. The method according to claim 67, wherein, when the transport vehicle is in position, the method comprises the steps of:
lowering all wheels of the first set of wheels and the second set of wheels to the rail system.

70. The method according to claim 67, wherein, when the transport vehicle is at a personnel transfer position, the method comprises a step of:
lowering a support into contact with the rail system.
